(19) United States
(12) Patent Application Publication
(10) Pub. No.: US 2026/0335799 A1
(43) Pub. Date: Oct. 29, 2026

(54) METHODS OF SURFACE TREATING HONEYCOMB BODIES WITH SACRIFICIAL PARTICLES

(71) Applicant: CORNING INCORPORATED, CORNING, NY (US)

(72) Inventors: Yunfeng Gu, Painted Post, NY (US); Brian Alan Kent, Horseheads, NY (US)

(21) Appl. No.: 19/113,039

(22) PCT Filed: Sep. 26, 2023
(86) PCT No.: PCT/US2023/033686

§ 371 Date: Mar. 19, 2025

Related U.S. Application Data
(60) Provisional application No. 63/412,013, filed on Sep. 30, 2022.

(51) Int. Cl. B01D 39/16; B01D 39/20; B01D 46/24; F01N 3/022

(52) U.S. Cl. CPC B01D 39/1661; B01D 39/2075; B01D 46/2429; B01D 46/24492; F01N 3/0222; B01D 2239/10; B01D 2239/1216; B01D 2279/30

(57) ABSTRACT

Methods for manufacturing a honeycomb structured article comprising delivering first particles from a first suspension of first particles axially into the channels by flowing the first particles into the honeycomb structure so at least some of the first particles are disposed in, over, and/or around the surface openings, and terminating the delivering of the first particles into the channels after a selected deposited amount of first particles has been deposited within the honeycomb structure, the selected deposited amount of first particles per volume of the honeycomb structure being greater than 0.01 grams/liter and less than 5.0 grams/liter, wherein the first particles are comprised of sacrificial particles comprised of an organic material comprised of macromolecules, one or more polymers, or combinations thereof. Second particles are then deposited over the first particles.

### CROSS REFERENCE TO RELATED APPLICATION

This application claims the benefit of priority under 35 U.S.C. § 119 of U.S. Provisional Application Ser. No. 63/412,013 filed on Sep. 30, 2022, the content of which is relied upon and incorporated herein by reference in its entirety.

### BACKGROUND

### Field

The present specification relates to methods of surface treating porous bodies, such as porous ceramic honeycomb bodies, with sacrificial particles.

### Technical Background

Wall-flow filters are employed to remove particulates from fluid exhaust streams, such as from combustion engine exhaust. Examples include diesel particulate filters used to remove particulates from diesel engine exhaust gases and gasoline particulate filters (GPF) used to remove particulates from gasoline engine exhaust gases. Exhaust gas to be filtered enters inlet cells and passes through the cell walls to exit the filter via outlet channels, with the particulates being trapped on or within the inlet cell walls as the gas traverses and then exits the filter.

### SUMMARY

Aspects of the disclosure pertain to porous filter bodies and methods for their manufacture, including the use of sacrificial material.

In one aspect, a method is disclosed herein of manufacturing an article comprising a honeycomb structure extending axially from a first face to a second face, the structure being comprised of a plurality of porous walls extending axially and having surfaces which define a plurality of axial channels, the walls having internal pores, wherein surfaces of the walls comprise surface openings to at least some of the internal pores, the method comprising: delivering first particles from a first suspension of first particles, and optionally a fluid, axially into the channels by flowing the first particles into the honeycomb structure to deposit the first particles onto the walls of the honeycomb structure such that at least some of the first particles are disposed in, over, and/or around the surface openings, terminating the delivering of the first particles into the channels after a selected deposited amount of first particles has been deposited within the honeycomb structure, wherein the selected deposited amount of first particles per volume of the honeycomb structure is greater than 0.01 grams/liter and less than 5.0 grams/liter, wherein the first particles are comprised of sacrificial particles comprised of an organic material comprised of macromolecules, one or more polymers, or combinations thereof.

The organic material may comprise protein particles, whey protein particles, collagen peptide particles, or combinations thereof. The organic material may comprise protein particles having a particle size of less than 10 μm.

The sacrificial particles may further comprise calcium and phosphorus.

The sacrificial particles may further comprise calcium, phosphorus, sodium, and potassium.

The organic material may comprise a starch.

The organic material may comprise a synthetic polymer.

The organic material may comprise polystyrene, polyacrylate, an oligomer, or combinations thereof.

The oligomer may comprise one or more polyolefins having a molecular weight of 5000 daltons or less.

The method may further comprise, after flowing the first suspension, delivering of second particles from a second suspension of second particles axially into the channels, thereby depositing the second particles onto the walls of the honeycomb structure, wherein the deposited sacrificial particles block at least some of the second particles from entering the internal pores of the walls. In embodiments, the sacrificial particles block at least a majority of the second particles from entering the internal pores of the walls. In embodiments, the sacrificial particles block all of the second particles from entering the internal pores of the walls. In embodiments, the second particles do not penetrate below the surfaces of the walls more than 25% of a transverse thickness of the walls. In embodiments, the second particles are not disposed below, i.e. do not penetrate below, the surfaces of the walls. The method may further comprise terminating the delivering of the second particles into the channels after a selected deposited amount of second particles has been deposited within the honeycomb structure, wherein the selected deposited amount of second particles per volume of the honeycomb structure is greater than 0.01 grams/liter and less than 8.0 grams/liter. In embodiments, the method further comprises terminating the delivering of the second particles when a deposited amount of second particles per volume of the honeycomb structure is in the range of 1.0 to 8.0 grams/liter. In embodiments, the method further comprises terminating the delivering of the second particles when a deposited amount of second particles per volume of the honeycomb structure is in the range of 2.0 to 7.0 grams/liter. In embodiments, the method further comprises terminating the delivering of the second particles when a deposited amount of second particles per volume of the honeycomb structure is in the range of 3.0 to 7.0 grams/liter. TheThe method may further comprise heating the honeycomb structure for one or more times and one or more temperatures sufficient to remove the sacrificial particles, or at least some of the sacrificial particles, from the honeycomb structure. In embodiments, at least some of the axial channels are blocked, or sealed, or plugged, during the delivering of the first particles and second particles flowing of the first and second suspension, to induce the carrier fluid to pass through one or more of the porous walls of the honeycomb structure from at least one channel to another adjacent channel, thereby inducing particle deposition by filtration.

The first suspension may be comprised of the first sacrificial particles and a carrier fluid. The carrier fluid may be gaseous; for example the carrier fluid may be a gas.

The majority of sacrificial particles are preferably disposed in a fraction of the internal pores of the walls which have surface openings to channels to which the first particles were delivered.

In embodiments, the majority of sacrificial particles do not penetrate below the surfaces of the walls more than 50% of a transverse thickness of the walls.

In embodiments, the sacrificial particles are not disposed below the surfaces of the walls defining open pores at the surface after the depositing, that is the sacrificial particles do not penetrate into the interior porosity of the walls.

In embodiments, at least some of the sacrificial particles bridge across at least some of the surface openings.

In embodiments, the deposited amount of the first particles per volume of the honeycomb structure is in the range of 0.1 to 5.0 grams/liter.

In embodiments, the deposited amount of the first particles per volume of the honeycomb structure is less than 4.0 grams/liter.

In embodiments, the deposited amount of the first particles per volume of the honeycomb structure is less than 3.0 grams/liter.

In embodiments, the deposited amount of the first particles per volume of the honeycomb structure is less than 2.0 grams/liter.

In embodiments, the deposited amount of the first particles per volume of the honeycomb structure is 0.1 to 3.0 grams/liter.

In embodiments, the deposited amount of the first particles per volume of the honeycomb structure is 0.1 to 2.0 grams/liter.

In embodiments, the deposited amount of the first particles per volume of the honeycomb structure is 0.1 to 1.5 grams/liter.

In embodiments, the sacrificial particles are of a particle size in the range of 0.1 to 4 μm.

In embodiments, the sacrificial particles are of a particle size in the range of 0.5 to 4 μm.

In embodiments, the sacrificial particles have a median particle size of from 0.1 to 3 μm.

In embodiments, the sacrificial particles have a median particle size between 200 and 600 nm.

The second particles may be comprised of a primary particle size in the range of 0.1 to 1 μm while in suspension prior to spraying.

In embodiments, the sacrificial particles are comprised of a secondary particle size in the range of 0.1 to 5 μm, after spraying, and/or upon deposition.

In embodiments, the second particles are comprised of a primary particle size in the range of 0.1 to 1 μm while in suspension prior to spraying and a secondary particle size in the range of 0.1 to 5 μm after spraying, and/or upon deposition.

The first suspension may comprise one or more liquids which are prevented from contacting the article, such as by heating and/or evaporation or other removal. The flow of the first particles may be kept at one or more temperatures in the range of 110-160 C before contacting the article.

The porous walls may have a surface porosity of 35% to 75%.

The porous walls may have a median pore size of 5 to 50 micrometers.

The porous walls may have a median pore size of 5 to 30 micrometers.

The porous walls may have a median pore size of 10 to 30 micrometers.

The loading of the sacrificial particles (for example protein particles) is preferably in the range of 0.1-2.0 g/L (grams per overall exterior dimension volume of the honeycomb body).

Additional features and advantages will be set forth in the detailed description, which follows, and in part will be readily apparent to those skilled in the art from that description or recognized by practicing the embodiments described herein, comprising the detailed description, which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

FIG. 1 schematically illustrates an embodiment of the methods disclosed herein, illustrating three steps: (1) deposition of sacrificial material (first particles) (SL), (2) deposition of filtration material (second particles) such as alumina agglomerates and/or aggregates thereof, and (3) burn-out of the sacrificial material (first particles) during heat treatment process.

FIGS. 2A and 2B are cross-sectional SEM images (perpendicular to the longitudinal or axial axis of the honeycomb structure, parallel to the cells and channels thereof) of two particulate filter bodies made without sacrificial material (FIG. 2A) and with sacrificial material (FIG. 2B) according to the present disclosure.

FIG. 3 is an SEM photograph of the surface of the above filter body after deposition of 5 g skim milk protein particles according to the present disclosure.

FIG. 4 shows milk protein particle size distributions of the skim milk using Nanotrac Wave used in three runs on three base filter bodies herein.

FIG. 5 graphically illustrates post-water resistance test FE loss of the skim milk-pretreated examples and examples without skim milk pretreatment, after each extremely high FE (99%) filter body example was heat treated by each of three heat treatments: 200 C, 485 C, 600 C.

FIG. 6 graphically illustrates post-water resistance test FE loss of the skim milk-pretreated examples and examples without skim milk pretreatment, after each very high FE (96%) filter body example was heat treated by each of three heat treatments: 200 C, 485 C, 600 C.

FIG. 7A graphically illustrates the impact of skim milk pretreatment on filtration performance of very high FE (96%) filter bodies with filtration material, as deposited, for Example Group 4, showing the dependence of FE on filtration material loading.

FIG. 7B graphically illustrates the impact of skim milk pretreatment on filtration performance of very high FE (96%) filter bodies with filtration material, as deposited, for Example Group 4, showing the dependence of FE on pressure dP.

FIG. 8A graphically illustrates filtration efficiencies versus filtration material loading on filter bodies after 485 C heat treatment for various sacrificial loadings.

FIG. 8B graphically illustrates filtration efficiencies versus filter pressure drop on the filter bodies of FIG. 8A after 485 C heat treatment for various sacrificial loadings.

FIG. 9 shows clean state FE loss of examples after water saturation test which followed 650 C/9 h thermal treatment.

FIG. 10 shows the protein particle size distribution of skim milk, milk powder, and Isopure protein particles for examples herein.

FIGS. 11A and 11B show SEM images of surface morphology of the honeycomb walls of examples preconditioned with sacrificial material.

FIGS. 12A and 12B shows SEM images of branched Isopure protein particles and non-fat milk protein particles, respectively, which have different shapes and morphologies, but have similar particle size in the range of 0.5-4 micrometers.

FIG. 13A schematically illustrates post-water FE loss of extremely high (about 99%) FE preconditioned filter bodies with filtration material.

FIG. 13B schematically illustrates post-water FE loss of very high (about 96%) FE preconditioned filter bodies with filtration material parts with non-preconditioned filter parts having inorganic deposits.

FIG. 14 shows the SEM images of surface morphology collagen peptide particles of the preconditioned filter body.

FIG. 15 shows the SEM image of as-sprayed branched Collagen protein particles. Their shape and morphology are different from Isopure protein particles and non-fat milk powder protein particles, while their size is similar in the range of 0.5-4 microns.

FIG. 16 shows the post-water saturation test FE loss, which is the FE difference before and after water saturation test, of various examples herein preconditioned with sacrificial material.

FIG. 17 schematically illustrates exemplary steps for an aerosol deposition process which can deposit sacrificial material and/or filtration material to a filter body.

FIG. 18 schematically depicts an exemplary apparatus for forming honeycomb bodies.

FIG. 19 schematically illustrates a filter body (unplugged) comprised of a plurality of intersecting walls defining a plurality of inner channels, the matrix being surrounded by an outer peripheral wall.

FIG. 20 schematically illustrates a plugged filter body comprised of a plurality of intersecting walls defining a plurality of inner channels, with some of the channels being plugged at each end, the matrix being surrounded by an outer peripheral wall.

FIG. 21 schematically illustrates an axial cutaway view of a plugged filter body comprised of a plurality of intersecting walls defining a plurality of inner channels, with some of the channels being plugged at each end, the matrix being surrounded by an outer peripheral wall, the plugging pattern forcing flow from inlet channels to outlet channels through the porous walls as indicated by arrows.

### DETAILED DESCRIPTION

Reference will now be made in detail to embodiments of methods for forming honeycomb bodies comprising a porous honeycomb body comprising deposits on, or in, or both on and in, the porous ceramic walls of the honeycomb body matrix, embodiments of which are illustrated in the accompanying drawings. In embodiments the honeycomb body matrix is a honeycomb structure such as a monolithic honeycomb, for example as produced via extrusion through a honeycomb die; or in other embodiments the honeycomb body matrix comprises two or more blocks or segments of honeycomb matrix which are included or bound together such as by cement. Deposits may comprise material that was deposited into the honeycomb body, as well as compounds that may be formed, for example, by heating, from one or materials that were deposited. For example, a binder material may be transformed by heating into an organic component which is eventually burned off or volatilized, while an inorganic component (such as silica) remains contained within the honeycomb filter body. Deposits of one or more types may be used as sacrificial deposits, or even sacrificial layers. Whenever possible, the same reference numerals will be used throughout the drawings to refer to the same or like parts.

### DEFINITIONS

As used in this specification and the appended claims, the singular forms “a”, “an”, and “the” encompass embodiments having plural referents, unless the content clearly dictates otherwise. As used in this specification and the appended claims, the term “or” is generally employed in its sense including “and/or” unless the content clearly dictates otherwise.

As used herein, “have”, “having”, “include”, “including”, “comprise”, “comprising” or the like are used in their open-ended sense, and generally mean “including, but not limited to”.

A “honeycomb body,” as referred to herein, comprises a ceramic honeycomb structure of a matrix of intersecting walls that form cells which define channels. The ceramic honeycomb structure can be formed, extruded, or molded from a plasticized ceramic or ceramic-forming batch mixture or paste. A honeycomb body may comprise an outer peripheral wall, or skin, which was either extruded along with the matrix of walls or applied after the extrusion of the matrix. For example, a honeycomb body can be a plugged ceramic honeycomb structure which forms a filter body comprised of cordierite or other suitable ceramic material. A plugged honeycomb body has one or more channels plugged at one, or both ends of the body.

A honeycomb body disclosed herein comprises a ceramic honeycomb structure comprising at least one wall supporting one or more particulate deposits for example which may be configured to filter particulate matter from a gas stream. The deposits can be in discrete regions or in some portions or some embodiments can form one or more layers of deposit material at a given location on the wall of the honeycomb body. The deposits according to some embodiments comprise inorganic material, in some embodiments organic material, and in some embodiments both inorganic material and organic material. For example, a honeycomb structure of a honeycomb body may, in one or more embodiments, be formed from cordierite or other porous ceramic material and further comprise material deposits disposed on or below wall surfaces of the cordierite honeycomb structure.

In some embodiments, a second type of deposit material comprises one or more inorganic materials, such as one or more ceramic or refractory materials.

As used herein, “green” or “green ceramic” are used interchangeably and refer to an unsintered or unfired material, unless otherwise specified.

The methods disclosed herein can be useful in applying a surface treatment to a an article, such as an article comprising porous walls, such as a filter or a particulate filter, which can provide an improved filtering effect, or filtration efficiency, of the particulate filter, such as a filter comprising a bare honeycomb body, or a filter comprising a honeycomb body with other material deposited thereon or therein, such as filtration material deposits, a layer, a membrane, and/or catalytic material.

The methods disclosed herein can be useful in adding sacrificial deposits to the surfaces of porous walls of the particulate filters, such as to prepare the particulate filter for further surface treatment by additional deposits like filtration deposits, such as those comprising one or more types of inorganic particles. In embodiments, methods are disclosed herein that can help enable both high filtration efficiency (FE) and low backpressure dP for particulate filters such as gasoline particulate filters. In embodiments, disclosed herein are methods of pre-conditioning a porous honeycomb body with a sacrificial layer such as a porous honeycomb body comprising a porous ceramic honeycomb structure, such as a honeycomb body which has been extruded, fired, and provided with a select pattern of plugging or sealing various cells or channels of the honeycomb matrix, including for example a bare honeycomb body which has not yet received other filtration deposits. For a given amount of filtration deposit, or inorganic deposit, loading, we have found that a particulate filter body may exhibit improved filtration efficiency with the utilization of the deposition of a sacrificial layer prior to deposition of those filtration deposits. That is, a higher filtration efficiency could be obtained under the same inorganic surface treatment loading when first treated with sacrificial deposits as described herein. Lower backpressures may additionally be obtained after burn-out of the sacrificial layer such as by heat treatment or thermal treatment or curing. In various embodiments, such surface treated particulate filter is suitable for filtering exhaust gas from lean burn gasoline direct injection (GDI) engines contain particulate matter such as carbonaceous soot (e.g., soot), i.e. for example, gasoline particulate filters (GPF) with a honeycomb structure for collecting particulate matter in exhaust gases from vehicles equipped with GDI engines.

One approach to manufacturing a suitable GPF high clean filtration efficiency is to deposit filtration deposits or a porous layer of inorganic material on the wall surfaces of the honeycomb matrix of a base (uncoated or undeposited) GPF. In various embodiments an ethanol-based aerosol deposition process can be utilized in which a flow of agglomerated alumina particles is generated by passing ethanol-based alumina slurry through a nozzle or multiple nozzles. The as-deposited filtration material, or in various embodiments as-deposited layer, comprises aggregates of alumina spherical agglomerates with a size in the range of submicrons to a few microns. In such embodiments we found that in the initial deposition some fine agglomerates could penetrate and be trapped inside pores of the base walls or even slip through pores.

We have found that an increase the filtration material loading to arrive at thicker and and/or tighter porous layer on the honeycomb walls could be achieved by a longer processing time, and/or by providing a honeycomb structure with porous walls of smaller pore diameter, however such approaches may result in the drawback of increased pressure drop across the filter (increased backpressure), in some cases significantly higher. The methods disclosed herein, which in embodiments comprise deposition of a sacrificial layer before deposition of filtration material (for example comprising inorganic material) and then removal of the sacrificial material such as during curing, help avoid increasing (and in some cases reduce) the filtration material loading on the particulate filter and help to reduce filtration material loading and help to avoid increasing (and in some cases reduce) backpressure, especially for high FE GPF products. The methods disclosed herein also preferably minimize, and even more preferably avoid, filling of the pores of the walls of the honeycomb matrix with sacrificial material, as well as with filtration material deposits. Thus for example a sacrificial layer, such as a layer of protein particles from skim milk can be applied on a bare honeycomb body before deposition of filtration material, and in various embodiments preferably using the same deposition apparatus and process for the sacrificial material and for the filtration material, e.g. an aerosol atomizing spray process with similar processing window. In embodiments, spraying skim milk and alumina suspension in the same way or even in the same chamber could simplify the process to make the production more practical and cost effective. Thus, for example, a sacrificial layer such as a sacrificial protein layer can function as a barrier layer to help reduce, or even avoid, penetration (or slipping) of filtration material such as alumina aggregates and agglomerates deeply into the pores of the walls of the honeycomb matrix, particularly at the beginning of the deposition process of the filtration material, such that, in embodiments, better utilization of filtration material can be achieved as well as ultimate higher filtration efficiency of the particulate filter, for example by applying less filtration material (lower filtration material loading) while still being able to achieve higher filtration efficiency, and preferably a lower filtration material loading amount entails a shorter deposition time, which can lead to lower production cost. The sacrificial material may then be burned out during subsequent curing or thermal treatment process, such as heating the honeycomb body to 485 C for 1 hour.

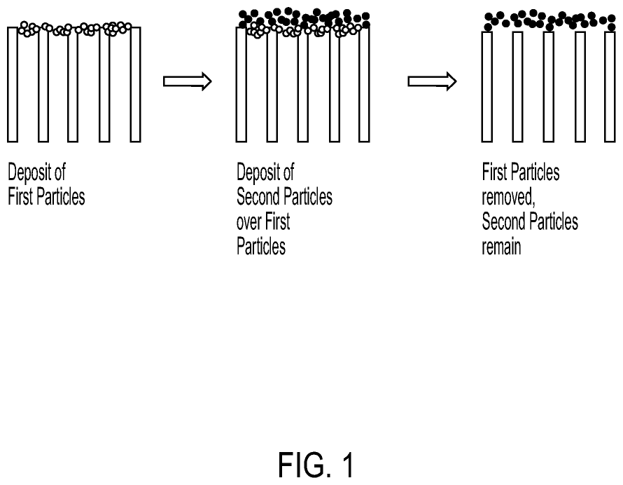

FIG. 1 schematically illustrates an embodiment of the methods disclosed herein, illustrating three steps: (1) deposition of sacrificial material (SL), (2) deposition of filtration material such as alumina agglomerates and/or aggregates thereof, and (3) burn-out of the sacrificial material during heat treatment process. The sacrificial material functions as a barrier to particles penetrating deep inside pores, or slipping through the pores, of the walls of the honeycomb matrix that define the channels. The sacrificial barrier deposits are particularly helpful during the beginning or early phase of the deposition of the filtration material. Preferably the majority of the first particles (or sacrificial particles) are deposited into channel-facing pores of the surfaces of the honeycomb walls, which allows the second particles (for example alumina particles) to have a degree of physical contact with the honeycomb wall which may be benefit thermal FE stability and water durability. We have found that FE loss was higher after thermal treatment when high protein loading (sacrificial particles) was applied, as demonstrated in the examples herein. Shallow penetration of the sacrificial particles is preferred, although in some embodiments deep penetration of sacrificial particles is acceptable.

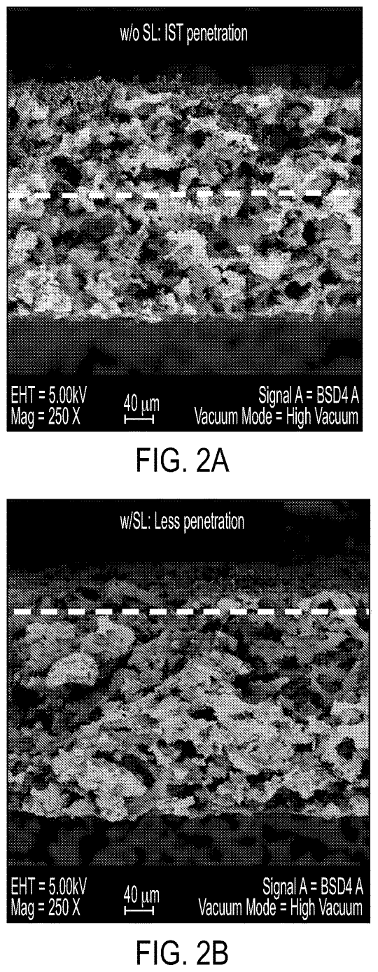

FIGS. 2A and 2B are cross-sectional SEM images (perpendicular to the longitudinal or axial axis of the honeycomb structure, parallel to the cells and channels thereof, of two particulate filter bodies made without sacrificial material (FIG. 2A) and with sacrificial material (FIG. 2B). As seen in FIG. 2A, deep bed penetration of filtration materials (here, alumina agglomerates) was observed without sacrificial material, including at the beginning of filtration material deposition, while much less penetration was observed on the honeycomb body with sacrificial material, as shown in FIG. 2B. We have found that less filtration material penetration leads to better utilization of filtration material, and leads to higher FE efficiency; that is, we have found that less filtration material loading is required to achieve a target FE. Also, less filtration material loading means shorter deposition time, and thus less production cost. During subsequent curing or thermal treatment process such as heating at 485 C, the sacrificial material can be burned out, thus leading to significant reduction in backpressure in the final particulate filter.

The pre-conditioning process which deposits sacrificial material can be carried out in a number of ways such as by various coating processes. For deposition of filtration material by filtration, where the filtration material is transferred to the filter body by a spraying process, preferably the same spraying process is utilized for the sacrificial material. For example, spraying an alumina suspension and spraying skim milk in the same way or even in the same chamber can make the process simpler, more practical and/or more cost effective. We have found that such spraying of skim milk exhibits significantly shorter processing time, much higher FE per sacrificial material (protein) loading, and smaller quantity required as compared to a soaking method such as disclosed in U.S. Pat. No. 7,767,256.

In various embodiments, the spray deposition mixing chamber temperature can be in the range of 110-160 C. The skim milk flow rate can be in the range of 4-36 g/min. The atomizing gas flow rate can be 5-20 Nm m³/hr. The drying gas flow rate can be 40-100 Nm m³/hr. An example of an apparatus with a spray deposition mixing chamber is described below.

As the starting parts for examples herein, filter bodies were utilized as the base honeycomb filter body (“base filter body”) which would be suitable for a gasoline particulate filter, the bodies comprising a primarily cordierite honeycomb structure comprising a matrix of interconnected porous ceramic walls having a bulk porosity of 55% was prepared, the walls forming a plurality of channels which were variously plugged at either an inlet and/or an outlet end such that an incoming gas would be forced to flow through the porous ceramic walls from inlet channels to outlet channels. The filter body had an outside diameter of 4.252 inches and an axial length of 4.724 inches. Sacrificial material in the form of 5 g of skim milk protein particles was deposited on the surfaces of the walls defining the inlet channels of the filter body. The protein particles having a particle size of 0.2-10 micrometers landed around the pores on the wall surfaces to partially or fully block the pore entrances at the surface of the base walls. Applying even more skim milk protein particles was observed to fully cover the pores. The amount of skim milk protein particles is an important parameter, and a select target amount of protein particles applied prior to the deposition of additional filtration materials onto the surfaces of the walls as described below could provide both filtration efficiency (FE) and minimal back pressure penalty, and even a reduction in engine operational back pressure for a comparative gasoline particular filter which did not benefit from utilization of sacrificial material. We have found that if the amount of protein particles is too low, improvement in the filtration efficiency and/or back pressure management could be limited, and if the amount of protein particles is too high, significant degradation of filtration efficiency could be experienced, such as due to thermal treatment.

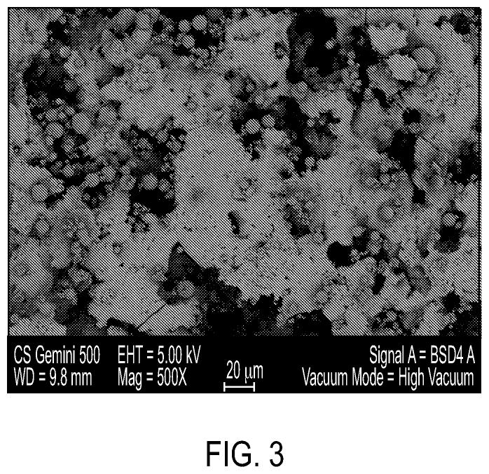

FIG. 3 is an SEM photograph of the surface of the above filter body after deposition of 5 g skim milk protein particles.

After the bare honeycomb body is pre-conditioned by the deposition of protein particles, such as by aerosol spray deposition process, one or more filtration materials can be deposited on the surface of the same wall surfaces, with at least some, or in some cases all, of the filtration material being deposited on top of the sacrificial layer. The filtration material can be applied by filtration process which employs, for example, an aerosol spray deposition process. The two-spray process may be conducted in the same spray chamber or in separate chambers.

We have found that, in general, the greater the amount of protein particles that is applied, the greater the FE improvement for a filter body in the clean state, or as-deposited state, can be observed before the filter cleans engine exhaust. Also, the greater the amount of protein particles that is applied, the higher the backpressure may occur. With skim milk protein particle pretreatment can thus lead to higher FE after deposition of filtration material. Another application is that lower filtration material loading is required to achieve the same FE in the finished filter product.

Additionally, bigger increases in FE can be obtained on bare (before any depositions) parts which have a lower initial filtration efficiency. For example, spraying the same amount 10 g of skim milk protein particles onto internal honeycomb wall surfaces of base filter bodies having the same dimensions as the example above (4.252 inches×4.724 inches) before application of the same amount of filtration material increased the as-deposited FE of such GPF parts by 1.8% from 96.3% to 98.1%, but only 0.1% FE improvement on such GPF parts from 99.2% to 99.3%.

After filtration material deposition, thermal treatment can be applied for both curing of the filtration material and for burning out the sacrificial material. The thermal treatment temperature(s) can comprise greater than 200 C, greater than 300 C, or greater than 400 C, which may depend on the type or amount of sacrificial material used. Generally, the majority of the sacrificial material should be decomposed or burned out, preferably with a weight loss of >80% of the amount of the sacrificial material originally deposited on the filter body. We have found that after deposition of filtration material and with removal of the sacrificial material, the filter bodies exhibit lower pressure drop compared with similar filter bodies except without pre-conditioning by sacrificial material. Filtration efficiency may depend upon on the quantity (amount) and morphology of sacrificial material. Generally, the greater the amount of applied sacrificial material that is applied, the more pressure drop dP reduction can be achieved, although more FE loss may occur due to thermal treatment. As shown in the following examples, the pre-conditioning process utilizing sacrificial material could provide both FE improvement and pressure drop reduction.

### Examples Group 1: Skim Milk Pretreatment Process: Spray Vs. Soaking

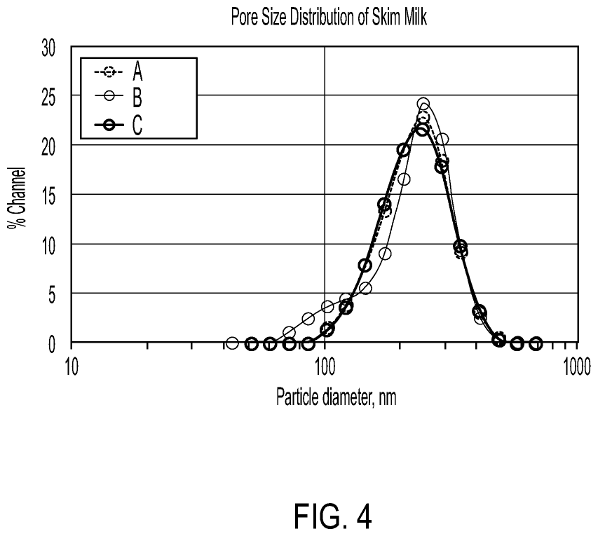

In this group, base filter bodies as described above were preconditioned with skim milk by two different methods: (a) spraying and (b) soaking or immersing. FIG. 4 shows protein particle size distribution of the skim milk using Nanotrac Wave. Three particle size distribution measurement runs were conducted on Grate Value skim milk purchased from Walmart in July, August and September. The protein particle size was in the range of 72-486 nm with the average d50=210.6, 215.5, and 209.7 nm, respectively. The concentration of solids in the skim milk was about 9.4%, which was measured by loss of dry at 115 C for 20 min.

The protein particle spraying process was conducted on the same apparatus that deposited filtration material to the filter bodies, and the amount or quantity of skim milk deposited on the filter bodies in this sub-group ranged from 5 to 15 g. Fixed spraying conditions were applied including 140 C for mixing chamber temperature, 12 g/min for protein particle liquid flow rate, 60 Nm m³/h for nitrogen drying carrier gas flow rate, and 10 Nm m³/h for nitrogen atomizing gas flow rate to atomize the skim milk. The spray time ranged from 25 to 75 seconds with use of the same nozzle as used for the filtration material.

The protein particle soaking process comprised two steps: soaking and drying. Before soaking, the bare base filter body was wrapped with polytetrafluroethylene tape to prevent the protein in skim milk from directly contacting the exterior of the porous substrate. Upon soaking in the specified quantity of skim milk for 20 seconds, the polytetrafluroethylene tape was taken off the substrate. The pre-treated filter body was dried for about 5 hours in ambient conditions and then moved into a 60 C oven and left drying there for 14 hours to get ready for filtration material deposition. In this sub-group, 150 g, 250 g and 500 g of skim milk was used for soaking the bare filter bodies, respectively.

Table 1 shows the protein loading in the dried preconditioned filter bodies made by the above two different processes, as well as the filtration efficiencies exhibited per a so-called smoke FE test which is a test that can evaluate the filtration efficiency even when the filter body is in a clean state. As seen in Table 1, spraying 5 g to 15 g skim milk led to increasing protein loading from 0.55 to 1.27 g/L, and smoke FE increased from 52.5% to 72.3%. As a comparison, soaking 150 g to 500 g skim milk led to protein loading increases from 13. 41 to 19.13 g/L but the smoke FE was not much changed and were generally in the low range of 30%. This soaking process was described in U.S. Pat. No. 7,767,256, which we found to not be an efficient process for forming a barrier layer or sacrificial layer.

TABLE 1
Comparison of the protein loading in the dried preconditioned substrates
made by two different processes and their smoke FE results.

| | Pretreatment | Skim | Protein | Smoke |
|---|---|---|---|---|
| Sample ID | process | milk, g | loading, g/L | FE |
| 1 | Spraying | 15 | 1.28 | 72.4% |
| 2 | Spraying | 15 | 1.27 | 72.3% |
| 3 | Spraying | 10 | 0.9 | 63.9% |
| 4 | Spraying | 10 | 0.9 | 63.6% |
| 5 | Spraying | 5 | 0.52 | 50.7% |
| 6 | Spraying | 5 | 0.58 | 54.3% |
| 7 | Soaking | 500 | 20.11 | 29.8% |
| 8 | Soaking | 500 | 18.26 | 30.6% |
| 9 | Soaking | 250 | 17.03 | 29.5% |
| 10 | Soaking | 250 | 16.66 | 30.2% |
| 11 | Soaking | 150 | 13.38 | 30.0% |
| 12 | Soaking | 150 | 13.45 | 33.0% |

### Examples Group 2: Extremely High FE Filter Bodies (FE Around 99%)

In this group, six (6) base filter bodies were treated with different quantities of skim milk (Great Value from Walmart) by the same spraying process as utilized for the filtration material, 2 filter bodies with 5 g skim milk, 2 filter bodies with 10 g skim milk, and 2 filter bodies with 15 g skim milk. The skim milk spraying parameters were fixed: 140 C for mixing chamber temperature, 12 g/min for liquid flow rate, 60 Nm³/h for nitrogen drying carrier gas flow rate, and 10 Nm m³/h for nitrogen atomizing gas flow rate to atomize the skim milk. Each pretreated filter body was put back into the spraying chamber and a 70 g of alumina suspension was atomized and mixed with carrier gas and transported as filtration material to the filter body using the same spraying parameters. The alumina suspension was an Almatis suspension (11% Almatis-1.33% TEA-1% Triblock-15% 2405 Dowsil) in ethanol. An additional two (2) filter bodies without skim milk pre-treatment were also prepared for comparison.

After deposition of the filtration material, the filter bodies were thermally treated and evaluated per the following heat treatment sequence: 1) 200 C for 1 h followed by water saturation test; 2) 485 C for 12 minutes followed by water saturation test; and 3) 650 C for 5 hours followed by water saturation test.

For the filter bodies in this group, the filtration material loading provided a very high clean state filtration efficiency (>90%) even for the examples which were not pretreated with skim milk. The skim milk pretreatment led to significantly lower pressure drop but limited improvement on FE; the FE increases with increasing filtration material loading, but the improvement in FE leveled off and barely increases after FE reaches very high values in the range of 98-99%.

Table 2 shows FE and dP of the examples, both without milk pretreatment and with various amounts of skim-milk pretreatment, after the same amount of filtration material deposition, immediately after deposition with no heat treatment (“as-deposited”) and after various temperature treatments: 200 C for 1 hour, 485 C for 12 minutes and 650 C for 5 hours.

TABLE 2

| | Milk | APT | As- | As- | Post- | Post- | Post- | Post- | Post- | Post- |
|---|---|---|---|---|---|---|---|---|---|---|
| | amount, | Totalizer, | deposit | deposit | 200C | 220C | 485C | 485C | 650C | 650C |
| | g | g | FE | dP | FE | dP | FE | dP | FE | dP |
| 13 | 0 | 70 | 99.20% | 253.4 | 99.23% | 253.4 | 99.14% | 251 | 99.01% | 240.8 |
| 14 | 0 | 70 | 99.21% | 252.2 | 99.16% | 255.8 | 99.15% | 252.6 | 99.04% | 246.2 |
| 15 | 5 | 70 | 99.21% | 252.4 | 99.26% | 254.2 | 99.13% | 245 | 99.01% | 236.8 |
| 16 | 5 | 70 | 99.22% | 255.6 | 99.28% | 258.2 | 99.24% | 248.6 | 99.17% | 238.6 |
| 17 | 10 | 70 | 99.28% | 251.2 | 99.33% | 252 | 99.27% | 233 | 99.03% | 222.4 |
| 18 | 10 | 70 | 99.31% | 261.6 | 99.33% | 258.2 | 99.18% | 230.2 | 98.99% | 228.4 |
| 19 | 15 | 70 | 99.33% | 260.6 | 99.31% | 254 | 99.07% | 225.4 | 98.58% | 213.8 |
| 20 | 15 | 70 | 99.27% | 262.4 | 99.28% | 242.4 | 99.07% | 227.4 | 98.71% | 214.2 |

The examples in Table 2 that were pretreated with 5 g skim milk showed similar as-deposited FE and pressure drop dP, and the examples pretreated with 10 g and 15 g skim milk showed slightly higher as-deposited FE and dP compared to the examples with no skim milk pretreatment. After exposure to curing temperature 200 C/1 h, there was a little change in FE and dP. The heat treatment at 485 C and 650 C led to slight decreases in FE however FE was still maintained at a very high level of 99% or above except for the examples with 15 g skim milk pretreatment, which exhibited the largest drop down to 98.6-98.7%. On the other hand, significant dP reduction was observed on the skim milk-treated examples, in particular, with more applied skim milk such as 10 g and 15 g. After 485 C/12 min heat treatment, the skim milk-treated examples showed lower dP compared to the examples without pretreatment: 2.0%, 8.0%, and 10.1% for 5 g, 10 g, and 15 g-milk treatment, respectively. After 650 C/5 h heat treatment, the skim milk-treated examples exhibited 2.4%, 7.4%, and 12.1% lower dP compared to the examples without pretreatment, for 5 g, 10 g, and 15 g-milk treatment, respectively.

We have found that filter body pre-conditioning with skim milk led to improvement in FE and dP, which can depend on the quantity of sprayed skim milk applied to the filter body. Compared to non-pretreated examples, after 650 C/5 h treatment, the 5 g-milk pretreated examples showed 0.1% higher FE and 2.4% lower dP. The 10 g-milk treated examples showed 7.4% lower dP while maintaining the same FE=99.0%. The 15 g-milk treated examples showed 12.1% lower dP but 0.3% lower FE.

Water saturation resistance can be a challenging requirement for filters enhanced by filtration material deposits. We found that the skim milk pretreatment does not negatively impact water resistance performance.

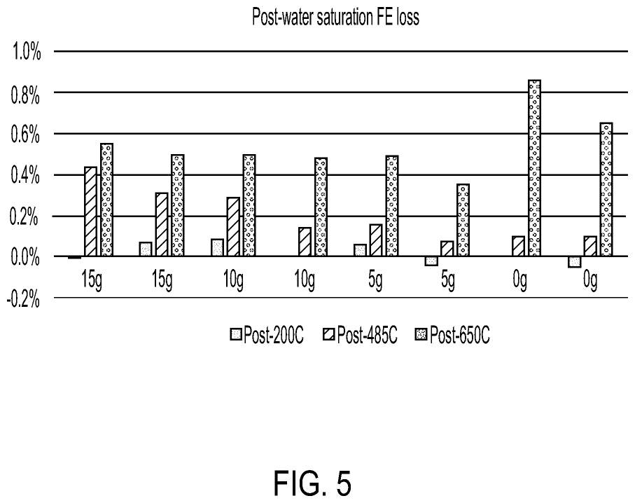

FIG. 5 shows the drop in FE fig (“FE loss”) of thermally treated examples due to a water saturation test. The 200 C-cured examples showed very good water resistance with FE loss less than 0.1%. After 485 C heat treatment, the 15 g-milk pretreated examples showed slightly higher post-water FE loss. After 650 C/5 h heat treatment, the milk-pretreated examples showed slightly better water resistance, 0.4-0.5% FE loss compared to the examples with no pretreatment, having 0.6-0.8% FE loss. The average total FE loss after the above three successive heat treatment cycles and water saturation test was 0.9% for the non-pretreated examples, 0.5% for 5 g-milk examples, 0.8% for 10 g-milk examples, and 1.2% for the 15 g-milk examples.

### Examples Group 3: Very High FE Filter Bodies (FE Around 96%)

This group of examples focused on the skim milk pretreatment process and the resulting improvement on filter performance for filter bodies with filtration material deposits which provide FE around 96%. In this example, six (6) base filter bodies were treated with different quantities of skim milk by aerosol spraying process, 2 examples with 5 g skim milk, 2 examples with 10 g skim milk, and 2 examples with 15 g skim milk. The skim milk spraying parameters were fixed: 140 C for mixing chamber temperature, 12 g/min for liquid flow rate, 60 Nm m³/h for nitrogen drying carrier gas flow rate, and 10 Nm m³/h for nitrogen atomizing gas flow rate. Then each pretreated example was put back into the spraying chamber and applied with a fixed totalizer 37 g of alumina suspension using the same spraying parameters. The alumina suspension was an ethanol-based Almatis suspension (11% Almatis-1.33% TEA-1% Triblock-15%2405 Dowsil). Two additional examples without skim milk pre-treatment were also prepared for comparison.

After final deposition of filtration material, the examples were thermally treated and evaluated per the following sequence: 1) 200 C for 1 h followed by water saturation test; 2) 485 C for 12 minutes followed by water saturation test; and 3) 650 C for 5 hours followed by water saturation test.

We have found that for the 96% clean FE examples, the skim milk pretreatment can both improve FE and reduce pressure drop.

Table 3 shows FE and dP for examples with filtration material as-deposited and after heat treatment at 200 C/1 h, 485 C/12 min and 650 C/5 h. After filtration material deposition, the examples pretreated with skim milk showed improvement on FE over examples without pretreatment. The greater amount of skim milk sprayed, the higher was the as-deposited FE, although the pretreated examples had higher pressure drop. Curing at 200 C/1 h led to slight FE drop in the range of 0.2-0.3% for all the examples, so the pretreated examples maintained higher FE but also exhibited higher dP.

After 485 C/12 min heat treatment, the pretreated examples maintained higher FE by 1.2-1.7% and their pressure drop dP values were close to or lower than examples without pretreatment, due to burn-out of the skim milk protein particles. The 5 g-milk pretreated examples had 1.4% higher FE and 0.9% higher dP. The 10 g-milk pretreated examples had 1.7% higher FE and 0.1% lower dP, and the 15 g-milk pretreated examples had 1.2% higher FE and 5.1% lower dP.

Further heat treatment at 650 C for 5 hours helped lower dP for the milk-pretreated examples, but also had somewhat reduced FE improvement. Compared to the examples without pretreatment, the 10 g-milk pretreated parts had 0.7% higher FE and 0.9% lower dP. The 15 g-milk pretreated parts had 6.4% lower dP but 0.9% lower FE.

Table 3 shows FE and dP of examples without milk pretreatment and skim-milk pretreated examples after filtration material deposition and heat treatment at different temperatures.

TABLE 3

| | Milk | APT | As- | As- | Post- | Post- | Post- | Post- | Post- | Post- |
|---|---|---|---|---|---|---|---|---|---|---|
| | amount, | Totalizer, | deposit | deposit | 200C | 220C | 485C | 485C | 650C | 650C |
| | g | g | FE | dP | FE | dP | FE | dP | FE | dP |
| 21 | 0 | 37 | 96.37% | 206.4 | 99.07% | 203.4 | 94.24% | 197.6 | 93.79% | 191 |
| 22 | 0 | 37 | 96.25% | 206.6 | 95.96% | 205 | 95.35% | 202.4 | 94.74% | 196 |
| 23 | 5 | 37 | 97.04% | 209.8 | 96.87% | 210.8 | 96.07% | 202.4 | 94.69% | 195 |
| 24 | 5 | 37 | 97.26% | 212 | 97.07% | 213.2 | 96.15% | 204.6 | 95.00% | 197 |
| 25 | 10 | 37 | 98.09% | 220.2 | 97.93% | 218.2 | 96.13% | 201.8 | 95.01% | 192.8 |
| 26 | 10 | 37 | 98.16% | 221.6 | 98.00% | 218.6 | 96.66% | 201 | 94.86% | 190.6 |
| 27 | 15 | 37 | 98.36% | 224.6 | 98.06% | 215 | 95.96% | 191.4 | 92.85% | 181.4 |
| 28 | 15 | 37 | 98.42% | 228.6 | 98.19% | 219 | 95.94% | 196.4 | 94.02% | 180.8 |

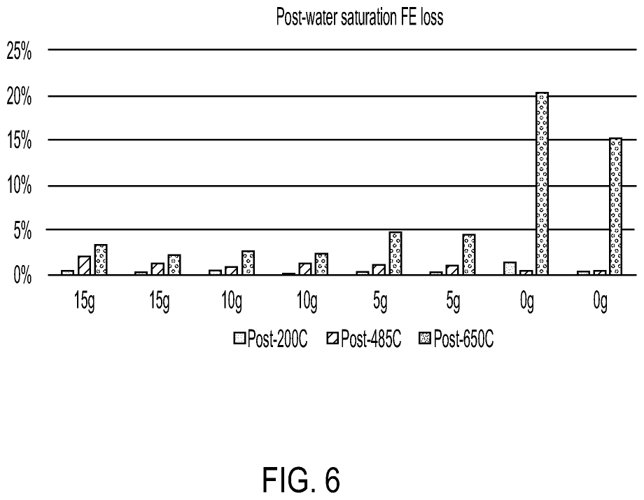

Water saturation resistance can be among the most challenging features to achieve for filter bodies with deposited filtration material. We found that the skim milk pretreatment did not produce a negative impact on the water resistance of those examples, and surprisingly appears to benefit water resistance after 650 C/5 h heat treatment, as shown in FIG. 6.

The 200 C-cured parts showed similar good water resistance. After 485 C heat treatment, the milk pretreated parts showed slightly higher post-water FE loss. After 650 C/5 h heat treatment, milk-pretreated parts showed significantly better water resistance, below 5% FE loss, while the non-treated examples lost 15-20% FE after water saturation. The average total FE loss after the three cycles of heat treatment and water saturation test was 20.4% for the non-treated example, 6.9% for 5 g-milk pretreated examples, 5.6% for 10 g-milk pretreated examples, and 7.8% for the 15 g-milk pretreated examples. The pretreated examples of Example Group 3 showed much higher total FE loss compared to the above examples of Example Group 2.

### Example Group 4: Impact of Liquid Flow Rate in the Skim Milk Spray Process on Performance of Filter Parts Having Inorganic Deposits

This example group focused on the impact of liquid flow rate in the skim milk spraying process on filtration performance. Base filter bodies were used as above. Table 4 lists three variables: milk flow rate (6, 12, 24 g/min), milk loading (5, 10, 15 g), and filtration material loading (70, 80 g). Also two examples were made without skim milk pretreatment for comparison. Fixed skim milk spraying parameters included 140 C for chamber temperature, 60 Nm m³/h for nitrogen drying carrier gas flow rate, and 10 Nm m³/h for nitrogen atomizing gas flow rate. Fixed filtration material deposition parameters included 140 C for chamber temperature, 12 g/min liquid flow rate, 60 Nm m³/h for nitrogen drying gas flow rate, and 10 Nm m³/h for nitrogen atomizing gas flow rate. An alumina suspension was used to supply filtration material, and an ethanol-based Almatis suspension (11% Almatis-1.33% TEA-1% Triblock-15% 2405 Dowsil) was used.

After deposition of filtration material, the examples were thermally treated at 485 C for 12 minutes followed by smoke FE and dP measurement, and then treated at 650 C for 9 hours before the water saturation test.

TABLE 4

| | Milk | Milk | APT |
|---|---|---|---|
| | Flowrate (g/min) | Totalizer (g) | Totalizer (g) |
| 29 | n/a | n/a | 70 |
| 30 | n/a | n/a | 80 |
| 31 | 6 | 5 | 80 |
| 32 | 6 | 10 | 80 |
| 33 | 6 | 10 | 70 |
| 34 | 6 | 15 | 80 |
| 35 | 10 | 5 | 80 |
| 36 | 10 | 10 | 80 |
| 37 | 10 | 10 | 70 |
| 38 | 10 | 15 | 80 |
| 39 | 24 | 5 | 80 |
| 40 | 24 | 10 | 80 |
| 41 | 24 | 10 | 70 |
| 42 | 24 | 15 | 80 |

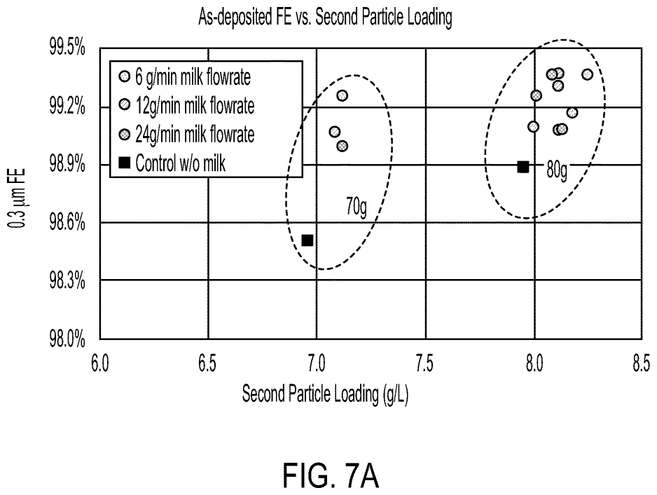

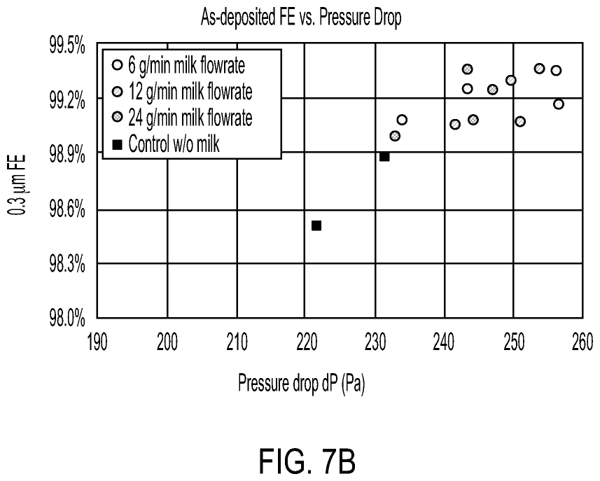

FIG. 7A graphically illustrates the impact of skim milk pretreatment on filtration performance of filter bodies with filtration material, as deposited, for Example Group 4, showing the dependence of FE on filtration material loading.

FIG. 7B graphically illustrates the impact of skim milk pretreatment on filtration performance of filter bodies with filtration material, as deposited, for Example Group 4, showing the dependence of FE on pressure dP.

FIGS. 7A-7B show the impact of skim milk pretreatment on as-deposited filtration performance. For a given amount of deposited filtration material (70 g or 80 g), the skim milk pretreated examples showed higher filtration material loading and as-deposit FE, indicating higher filtration materials utilization rate and higher FE efficiency. Furthermore, the skim milk pretreated examples with 70 g filtration material loading showed higher FE than the non-pretreated examples with 80 g loading, as shown in FIG. 7A. On the other hand, skim milk pretreatment did not impact the FE/dP curve.

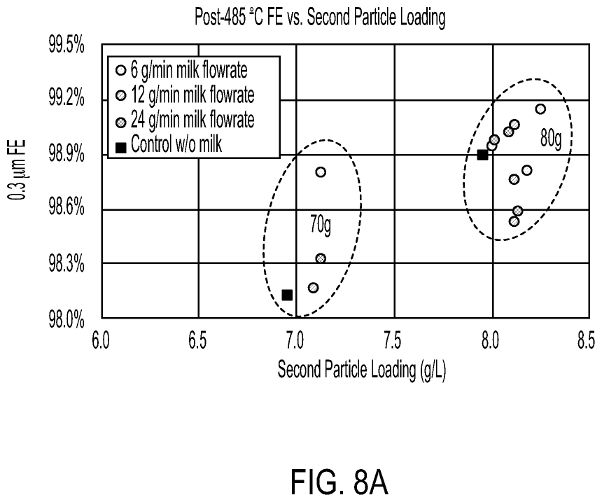

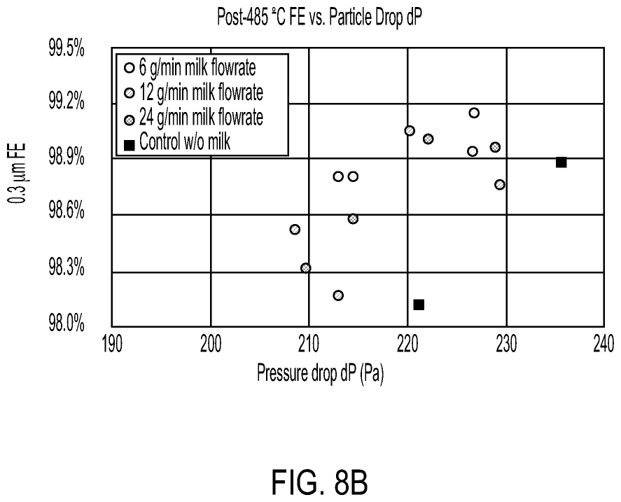

After thermally treated at 485 C for 12 minutes, the skim milk pretreated examples, in particular with 15 g skim milk had higher FE loss. As shown in FIG. 8A, for the same filtration material loading, the skim milk pretreated examples showed higher post 485 C FE except for the examples with 15 g milk totalizer. On the other hand, the FE/dP curve for the skim milk pretreated examples was shifted to the left, indicating lower dP for the same FE. Lower milk flow rate appears to yield better filtration performance. Example 210602-2A pretreated with 10 g milk at 6 g/min flow rate showed very good filtration performance, 99.15% FE and 226.6 Pa pressure drop, with comparison to the non-pretreated example 210602-17 with FE=98.89% and dP=235.6 Pa. Example 210602-5A pretreated with 15 g milk at 6 g/min flow rate showed FE=98.81% and dP=212.8 Pa, about 9.7% lower dP compared to the non-pretreated example.

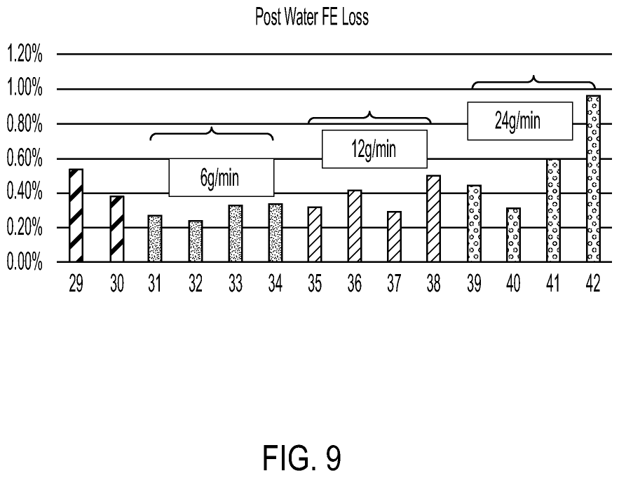

FIG. 9 shows smoke FE loss of examples after water saturation test which followed 650 C/9 h thermal treatment. All examples showed less than 1% FE loss. Among the milk pretreated parts, lower milk flow rate resulted in better water resistance.

We tested several brands of skim milk and found no significant differences in filtration performance.

We also made other examples with other sources of protein particles, using non-fat dry milk powder, Isopure protein 100% whey powder, and collagen peptides whey protein.

### Example Group 5: Milk Powder and Isopure Protein Powder as Skim Milk Alternatives

Non-fat dry milk powder and Isopure protein 100% whey powder were used to precondition base filter bodies as described above. Isopure protein powder is a whey protein made from a water-soluble milk protein, and comprises amino acids.

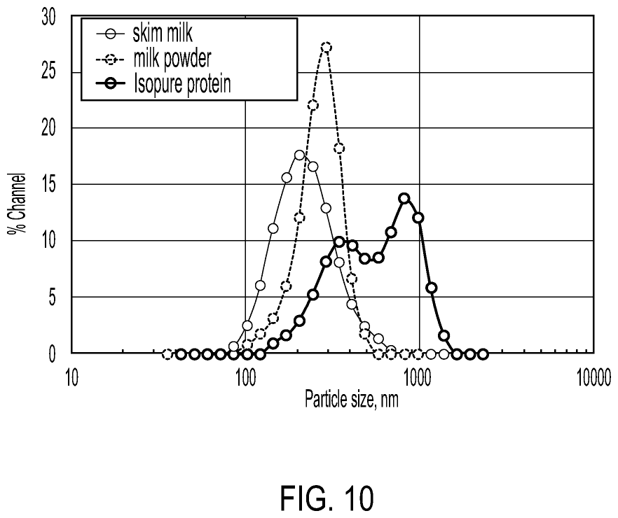

Firstly, two preconditioning suspensions with a solid loading of 9% by weight were made by adding 9 grams of milk powder and Isopure protein powder, respectively, into 91 grams of water followed by shaking for a couple of minutes. The resulting suspensions were stable without settling. FIG. 10 shows the protein particle size distribution of skim milk, milk powder, and Isopure protein. The non-fat milk powder in water showed single-modal particle distribution with d50=249 nm, and the Isopure protein powder in water showed bi-modal particle distribution with d50=517 nm.

Secondly, two sets of bare base filter bodies were preconditioned in an aerosol spray chamber by spraying 10 grams milk powder suspension and Isopure protein suspension, respectively, with the same processing parameters as spraying skim milk in Example Group 2. The preconditioned examples had protein loading in the range of 0.74 to 0.84 g/L as shown in Table 1, and FE in the range of 60-65%.

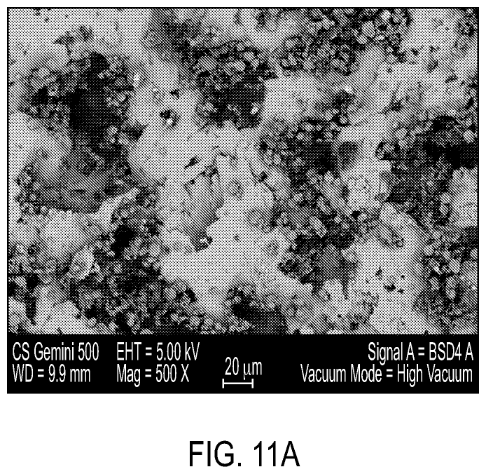

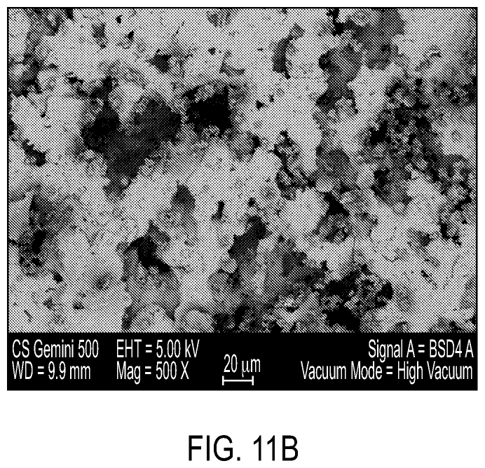

FIGS. 11A and 11B show SEM images of surface morphology of the honeycomb walls of preconditioned examples. The majority of the protein particles landed around the entrance of the pores at the wall surfaces, partially or fully covering the pores.

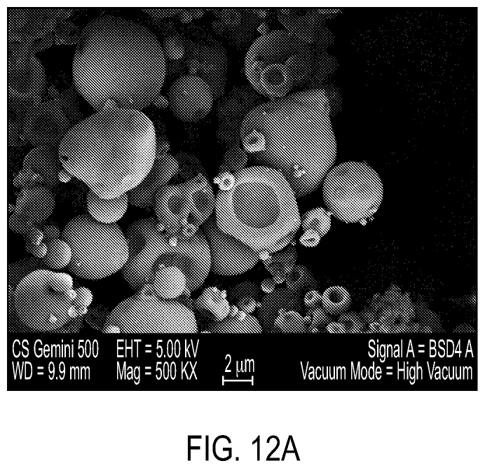

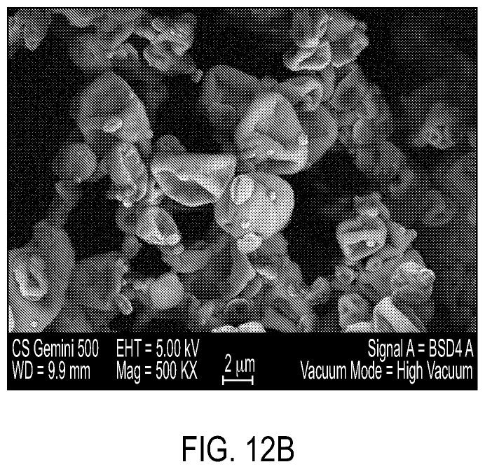

FIGS. 12A and 12B shows SEM images of branched Isopure protein particles and non-fat milk protein particles, respectively, which have different shapes and morphologies, but have similar particle size in the range of 0.5-4 micrometers.

Thirdly, three bare base filter bodies without pre-conditioning were put into a spray chamber and sprayed with 80 grams and 43 grams of the alumina suspension (11% Almatis-1% TEA-1% Triblock-15% 2405 Dowsil), leading to as-deposited FE in the range of 99% and 96%, respectively. Then all pretreated examples were sprayed with either 80 grams or 34 grams of the same alumina suspension, as listed in Table 1 Table 5. The spray conditions for alumina suspension were the same as in Example Group 2. We found that for the same filtration material delivered by the spray mixing chamber, the filtration material loading of pretreated examples on the filter bodies were higher than that of non-pretreated examples. As an example, after spraying 80 grams of alumina suspension, the resulted filtration material loadings were 7.63 g/L and 8.18-8.39 g/L for non-pretreated examples and pretreated examples, respectively. After spraying 34 grams of alumina suspension onto the filter bodies, the resulting filtration material loadings were 4.19-4.20 g/L and 4.41-4.46 g/L for non-pretreated examples and pretreated examples, respectively. Without being held to any theory, we believe that no, or fewer, alumina agglomerates slipped through pores of the filter bodies and exited through the outlet channels of the filter bodies for the pretreated samples because protein particles covered the pores. After filtration material deposition, all examples were thermally treated at 485 °C for 12 minutes followed by smoke FE measurement and dP measurement. The water saturation test was conducted after thermal treatment at 650 °C for 9 hours.

FIGS. 12A and 12B show SEM images of surface morphology of the filter bodies preconditioned by a) Isopure protein and b) non-fat milk powder protein, respectively.

Table 1 Table 5 shows that all preconditioned filter body parts showed both higher as-deposited FE and higher pressure drop dP compared to the parts that were not pretreated. Much more FE improvement was observed with very high FE filter body parts (FE-96%) than with extremely high FE filter body parts (FE=99%). After burn-out of milk particles or protein particles by thermal treatment at 485 °C, the preconditioned parts had 4%-7% lower dP than the non-preconditioned parts under the same level of filtration material loading, while FE was similar. Further thermal treatment at 650 °C led to 6%-13% lower dP for the preconditioned parts.

TABLE 1 TABLE 5
Comparison of FE and dP of the control parts (no pretreatment) and the
pretreated parts after inorganics deposition and 2 cycles of thermal treatment at different
temperatures.

| | | | | | | | | Post- | | Post- |
|---|---|---|---|---|---|---|---|---|---|---|
| | | Precondition | IST | IST | As- | As- | Post- | 485C | Post- | 650C |
| | | Loading, | totalizer, | loading, | deposit | deposit | 485C | dP, | 650C | dP, |
| | Preconditioning | g/L | g | g/L | FE | dP, Pa | FE | Pa | FE | Pa |
| 43 | No | N/A | 80 | 7.63 | 99.19% | 294.4 | 99.15% | 254.4 | 99.15% | 253.4 |
| 44 | No | N/A | 43 | 4.19 | 96.30% | 203.4 | 95.96% | 205.2 | 95.71% | 206.0 |
| 45 | No | N/A | 43 | 4.20 | 96.17% | 203.4 | 95.92% | 204.0 | 95.78% | 204.6 |
| 46 | Isopure protein | 0.83 | 80 | 8.18 | 99.48% | 258.2 | 99.41% | 249.0 | 99.02% | 219.6 |
| 47 | Isopure protein | 0.79 | 80 | 8.39 | 99.48% | 260.8 | 99.34% | 231.0 | 99.15% | 221.8 |
| 48 | Isopure protein | 0.77 | 43 | 4.41 | 98.51% | 230.6 | 96.79% | 194.6 | 96.02% | 188.2 |
| 49 | Isopure protein | 0.84 | 43 | 4.46 | 98.26% | 225.8 | 96.76% | 193.6 | 95.71% | 187.2 |
| 50 | Milk powder | 0.76 | 80 | 8.23 | 99.18% | 256.6 | 99.11% | 238.0 | 99.12% | 231.2 |
| 51 | Milk powder | 0.74 | 80 | 8.22 | 99.31% | 256.2 | 99.24% | 234.4 | 99.10% | 230.4 |
| 52 | Milk powder | 0.75 | 43 | 4.45 | 98.09% | 214.4 | 96.32% | 193.2 | 95.94% | 191.0 |
| 53 | Milk powder | 0.84 | 43 | 4.41 | 98.46% | 223.8 | 96.63% | 198.4 | 96.21% | 193.8 |

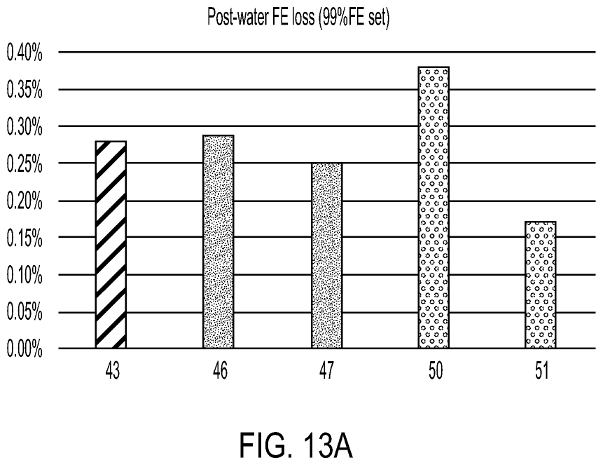

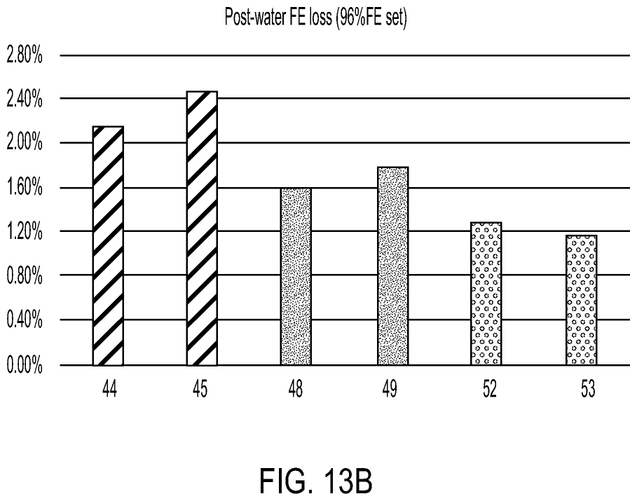

FIG. 13A schematically illustrates post-water FE loss of extremely high (about 99%) FE preconditioned filter bodies with filtration material. FIG. 13B schematically illustrates post-water FE loss of very high (about 96%) FE preconditioned filter bodies with filtration material parts with non-preconditioned filter parts having inorganic deposits.

FIGS. 13A-13B schematically illustrate the post-water saturation test FE loss, which is the difference in filtration efficiency before and after water saturation test. The preconditioned examples showed similar or slightly lower FE loss, indicative of comparable or even better water resistance than non-pretreated filter bodies. Generally, the extremely high FE (99%) filter bodies (FIG. 13A) had significantly lower FE loss than the very high FE (96%) filter bodies (FIG. 13B).

### Experiment #2 Example Group 6: Collagen Protein Powder and Skim Milk

Collagen peptides whey protein was used for preconditioning bare base filter bodies described above. Collagen peptides are very small pieces of protein from animal collagen. Collagen peptides are made by breaking down whole collagen proteins into smaller pieces.

Firstly, 9 grams of Collagen peptides was mixed with 91 grams of water to form the preconditioning suspension with a solid loading of 9% by weight. The resulting suspension was stable without settling. The particle size of the suspension was too small to be detected by light scattering analyzer. Secondly, one set of base filter bodies was preconditioned in the spray mixing chamber by spraying 10 grams of the solution with the same processing parameters as spraying skim milk in the above Example Group 2. The precondition amount delivered to the filter body was 10 grams as shown in Table 2 Table 6. Post precondition measurements showed that the parts had protein loading in the range of 0.66 to 0.83 g/L and FE in the range of 64-65%.

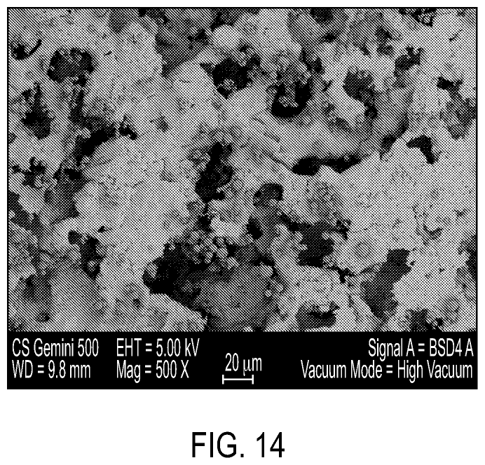

FIG. 14 shows the SEM images of surface morphology collagen peptide particles of the preconditioned filter body. The majority protein particles were deposited on the entrance of the substrate pores, partially or fully covering the pores.

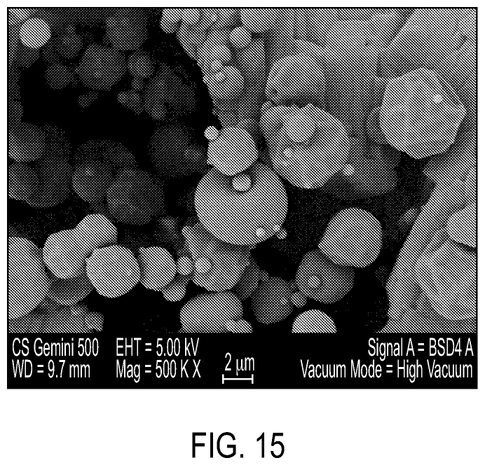

FIG. 15 shows the SEM image of as-sprayed branched Collagen protein particles. Their shape and morphology are different from Isopure protein particles and non-fat milk powder protein particles, while their size is similar in the range of 0.5-4 microns.

Thirdly, another set of bare base filter bodies without pre-conditioning were put into the same spray deposition chamber and sprayed respectively with 80 grams and 45 grams of the alumina suspension (11% Almatis-1% TEA-1% Triblock-15% 2405 Dowsil), leading to an as-deposited FE in the range of 99% and 96%, respectively. Then all pretreated filter bodies were sprayed with either 80 grams or 34 grams of the same alumina suspension. The amount of filtration material delivered was was 80 grams or 34 grams as shown in Table 2 Table 6. The spray conditions for alumina suspension were the same as in Example Group 2 above. After filtration material deposition, all filter bodies were thermally treated at 485 °C for 12 minutes followed by smoke FE and dP measurement. The water saturation test was conducted after thermal treatment at 650 °C for 9 hours.

TABLE 2. TABLE 6
Comparison of FE and dP of the control parts (no pretreatment) and
the pretreated parts after inorganics deposition and 2 cycles of thermal treatment at different
temperatures.

| | | | | | | | | Post- | | Post- |
|---|---|---|---|---|---|---|---|---|---|---|
| | | | IST | IST | As- | As- | Post- | 485C | Post- | 650C |
| | Precondition | Precondition | totalizer, | loading, | deposit | deposit | 485C | dP, | 650C | dP, |
| | totalizer, g | loading, g/L | g | g/L | FE | dP, Pa | FE | Pa | FE | Pa |
| 54 | 0 | 0 | 45 | 4.29 | 96.20% | 199.4 | 95.90% | 206.0 | 95.36% | 199.4 |
| 55 | 0 | 0 | 45 | 4.35 | 96.24% | 197.0 | 95.74% | 205.2 | 95.43% | 199.6 |
| 56 | 0 | 0 | 80 | 7.91 | 99.26% | 238.8 | 99.12% | 247.0 | 99.11% | 240.6 |
| 57 | 0 | 0 | 80 | 7.84 | 99.16% | 238.2 | 99.03% | 244.2 | 99.05% | 239.0 |
| 58 | 10 | 0.66 | 45 | 4.63 | 98.54% | 225.4 | 96.87% | 199.8 | 96.33% | 190.8 |
| 59 | 10 | 0.76 | 45 | 4.46 | 98.17% | 222.0 | 96.07% | 192.8 | 95.72% | 188.8 |
| 60 | 10 | 0.8345 | 80 | 7.98 | 99.45% | 259.4 | 99.11% | 231.6 | 98.97% | 221.4 |

Table 2 Table 6 shows that all preconditioned filter bodies had higher as-deposited FE than the non-preconditioned filter bodies, and very high FE filter bodies with filtration deposits (FE=96%) displayed much better FE improvement (around 2%) than extremely high FE filter bodies (FE=99%) (about 0.24%). All preconditioned filter bodies had higher as-deposited pressure drop dP, however, after burn-out of protein at 485 °C, the preconditioned parts showed 4.5-5.7% lower dP than the non-preconditioned parts under the same level of filtration material delivered, while FE was similar or slightly higher. Further thermal treatment at 650 °C led to 4.9%-7.7% lower dP for the preconditioned filter bodies.

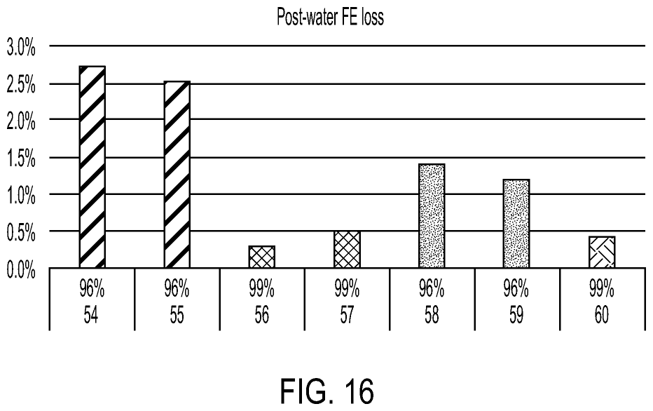

FIG. 16 shows the post-water saturation test FE loss, which is the FE difference before and after water saturation test. The preconditioned filter bodies showed similar or slightly lower FE loss, indicative of similar or better water resistance. For example, for the same very high FE (FE=96%) set, the non-pretreated samples showed FE loss of 2.54% and 2.74%, while the pretreated samples had FE loss of 1.20-1.41%. Overall, the extremely high FE (FE=99%) demonstrated significantly lower FE loss than the very high FE (FE=96%) filter bodies.

FIG. 16 Comparison of post-water FE loss of preconditioned filter parts having inorganic deposits with non-preconditioned filter parts having inorganic deposits.

All preconditioned parts showed good water durability with respect to FE loss after post-650 C/9 h heat treatment and water saturation test, all less than 1% drop in FE.

Methods disclosed herein comprise the application of a material such as a filtration material such as an inorganic material such as a ceramic or refractory material or even a porous ceramic or refractory material. In specific embodiments, the filtration material is an aerosol-deposited filtration material. In some preferred embodiments, the filtration material comprises a plurality of inorganic particle agglomerates, wherein the agglomerates are comprised of inorganic, such as ceramic or refractory, material. In some embodiments, the agglomerates are porous, which may allow gas to flow through the agglomerates.

Aerosol deposition enables deposition of filtration material onto the porous ceramic walls, which can be discrete regions as small as a single agglomerate or larger such as a plurality of agglomerates, and in some embodiments is in the form of a porous layer of filtration material, on or in, or both on and in, at least some surfaces of the walls of the ceramic honeycomb body. In certain embodiments, an advantage of the aerosol deposition method according to one or more embodiments is that ceramic honeycomb bodies with enhanced filtration performance can be produced economically, and/or more efficiently.

In embodiments, an aerosol deposition process disclosed herein comprises: mixture preparation (e.g., inorganic material, liquid vehicle, and binder), atomizing the mixture with an atomizing gas with a nozzle to form agglomerates and/or aggregates, comprised of the inorganic material, the liquid vehicle, and the binder if any, drying the agglomerates and/or aggregates in the presence of a carrier gas or a gaseous carrier stream, depositing the aggregates and/or agglomerates onto the honeycomb bodies, and optionally curing the material. The liquid vehicle may comprise ethanol. In some embodiments, walls of the apparatus can be heated to assist in drying the aggregates and/or agglomerates.

In various embodiments, the carrier gas can be heated in addition to, or rather than, heating walls of the apparatus, such that liquid vehicle can evaporate from the agglomerates faster, which in turn allows agglomerates to be generated more efficiently. A heated gaseous carrier stream carries both the atomized droplets and the agglomerates formed through the apparatus and into the honeycomb body. In some embodiments, atomizing gas is heated, alone or in combination with heating the carrier gas. In some embodiments, co-flowing the aerosolized droplets and/or agglomerates and the gaseous carrier stream in substantially the same direction into a chamber of an apparatus may help to reduce material loss or overspray on walls of the apparatus. Furthermore, a convergent section can be added to the apparatus before the agglomerates enter the ceramic honeycomb body in order to help the gas flow and particle tracking to be more uniform across the apparatus. An inner diameter of the end of the convergent section can be slightly larger than an outer diameter of the ceramic honeycomb body outer diameter in order to reduce or eliminate boundary effects of non-uniform particle deposition.

In an atomizing nozzle, or atomizer, high pressure and/or high speed atomizing gas can be used to break-up the suspension, which contains a mixture of liquid vehicle, binder, and solid particles, into small liquid droplets, for example with average droplet size of 4-6 micrometers. Heating of these liquid droplets and quick evaporation of the liquid vehicle creates porous inorganic agglomerates before depositing on the honeycomb body walls as a porous inorganic feature or structure. In some embodiments more than one nozzle is utilized, even in some cases under the same operating conditions, such that the liquid flow through each nozzle is reduced and droplet sizes can be smaller.

According to one or more embodiments, a process is disclosed herein comprising forming an aerosol with a binder, which is deposited on a honeycomb body to provide a high filtration efficiency material, which may be present in discrete regions and/or in some portions or some embodiments in an inorganic layer, on the honeycomb body to provide a particulate filter.

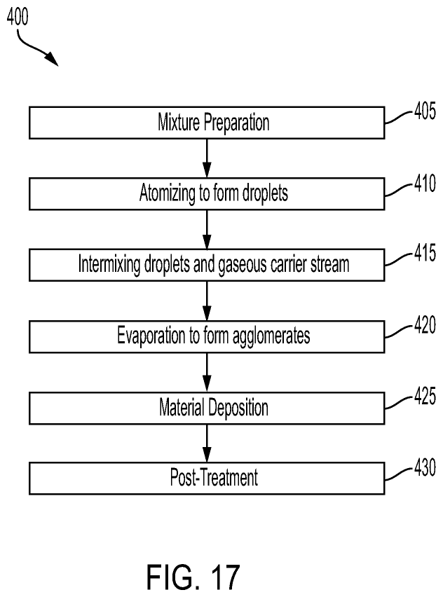

According to one or more embodiments, as shown in FIG. 17, the process 400 comprises the steps of mixture preparation 405, atomizing to form droplets 410, intermixing droplets and a gaseous carrier stream 415; evaporating liquid vehicle to form agglomerates 420, depositing of material, e.g., agglomerates, on the walls of a wall-flow filter 425, and optional post-treatment 430 to, for example, bind the material on, or in, or both on and in, the porous walls of the honeycomb body. Aerosol deposition methods form of agglomerates comprising a binder can provide a high mechanical integrity even without any high temperature curing steps (e.g., heating to temperatures in excess of 1000 °C), and in some embodiments even higher mechanical integrity after a curing step such as a high temperature (e.g., heating to temperatures in excess of 1000 °C) curing step. In the process in FIG. 17, the aerosol deposition forms inorganic material deposits, which in some specific embodiments are porous material deposits. In some embodiments, the material deposits are in the form of discrete regions of filtration material. In some embodiments, at least some portions of the material deposits may be in the form of a porous inorganic layer.

Inorganic particles can be used as a raw material in a mixture in the formation of an inorganic material for depositing. According to one or more embodiments, the particles are oxide- or carbide-ceramics; in embodiments the particles are selected from Al₂O₃, SiO₂, TiO₂, CeO₂, ZrO₂, SiC, MgO and combinations thereof. In one or more embodiments, the mixture is a suspension. The particles may be supplied as a raw material suspended in a liquid such as a liquid ethanol vehicle to which a further liquid vehicle is optionally added.

In one or more embodiments, the particles have an average primary particle size in a range of from about 10 nm to 4 about micrometers, about 10 nm to about 3 micrometers or from about 10 nm to about 2 micrometers, or from about 10 nm to about 900 nm or from about 10 nm to about 600 nm. In specific embodiments, the average primary particle size is in a range of from about 100 nm to about 200 nm, for example, 150 nm. The average primary particle size can be determined as a calculated value from the BET surface area of the aerosol particles, which in some embodiments is 10 m²/g.

In one or more embodiments, the primary particles comprise a ceramic particle, such as an oxide particle, for example Al₂O₃, SiO₂, MgO, CeO₂, ZrO₂, CaO, TiO₂, cordierite, mullite, SiC, aluminum titanate, and mixture thereof.

The mixture can be formed using a solvent which is added to dilute the suspension if needed. Decreasing the solids content in the mixture could reduce the aggregate size proportionally if the droplet generated by atomizing has similar size. The solvent should be miscible with suspension mentioned above, and be a solvent for binder and other ingredients.

Binder can be optionally added to reinforce the agglomerates and to provide a stickiness or tackiness, and can comprise inorganic binder, to provide mechanical integrity to deposited material. The binder can provide binding strength between particles at elevated temperature (>500 °C). The starting material can be organic. After exposure to high temperature in excess of about 150 °C, the organic starting material will decompose or react with moisture and oxygen in the air, and the final deposited material composition could comprise Al₂O₃, SiO₂, MgO, CeO₂, ZrO₂, CaO, TiO₂, cordierite, mullite, SiC, aluminum titanate, and mixture thereof. An exemplary binder content is in the range of greater than or equal to 5% by weight to less than or equal to 25% by weight of the particle content. In an embodiment, the binder content is 15 to 20% by weight ±1%.

Catalyst can be added to accelerate the cure reaction of binder. An exemplary catalyst content is 1% by weight of the binder.

The mixture may be atomized into fine droplets by high pressure gas through a nozzle. The atomizing gas can contribute to breaking up the liquid-particulate-binder stream into the droplets.

In one or more embodiments, the liquid-particulate-binder droplets are directed into the chamber by a nozzle.

In one or more embodiments, the liquid-particulate-binder droplets are directed into the chamber by a plurality of nozzles. In one or more embodiments, atomizing the plurality of liquid-particulate-binder streams occurs with a plurality of atomizing nozzles.

In embodiments the average droplet size according to one or more embodiments may be in the range of from 1 micrometer to 40 micrometers, including for example, in a range of greater than or equal to 1 micrometer to less than or equal to 15 micrometers; greater than or equal to 2 micrometers to less than or equal to 8 micrometers; greater than or equal to 4 micrometers to less than or equal to 8 micrometers; and greater than or equal to 4 micrometers to less than or equal to 6 micrometers; and all values and subranges therebetween. The droplet size can be adjusted by adjusting the surface tension of the mixture, viscosity of the mixture, density of the mixture, gas flow rate, gas pressure, liquid flow rate, liquid pressure, and nozzle design. In one or more embodiments, the atomizing gas comprises nitrogen. In one or more embodiments, the atomizing gas may consist essentially of an inert gas. In one or more embodiments, the atomizing gas may is predominantly one or more inert gases. In one or more embodiments, the atomizing gas may is predominantly nitrogen gas. In one or more embodiments, the atomizing gas may is predominantly air. In one or more embodiments, the atomizing gas may consist essentially of nitrogen or air. In one or more embodiments, the atomizing gas may be dry. In one or more embodiments, the atomizing gas may comprise essentially no liquid vehicle upon entry to the chamber.

The suspension flow rate is in the range of 10 to 40 g/minute, including all values and subranges therebetween, including 18 g/min.

The atomizing gas flow rate nitrogen flow rate is in the range of 2 to 10 Nm³/hr, including all values and subranges therebetween, including 5-6 Nm³/hr.

In one or more embodiments, the suspension comprises an inorganic material, a liquid vehicle, and in some embodiments, a binder, which is supplied to the nozzle as a liquid-particulate-binder stream. That is, particles of an inorganic material can be mixed with a liquid vehicle and a binder material to form a liquid-particulate-binder stream. The liquid-particulate-binder stream is atomized with the atomizing gas into liquid-particulate-binder droplets by the nozzle. In one or more embodiments, the liquid-particulate-binder stream is mixed with the atomizing gas. In one or more embodiments, the liquid-particulate-binder stream is directed into the atomizing nozzle thereby atomizing the particles into liquid-particulate-binder droplets. Preferably, the liquid-particulate-binder droplets are comprised of non-aqueous vehicle, the binder material, and the particles.

The droplets may be conveyed toward the honeycomb body by a gaseous carrier stream. In one or more embodiments, the gaseous carrier stream comprises a carrier gas and the atomizing gas. In one or more embodiments, at least a portion of the carrier gas contacts the atomizing nozzle. In one or more embodiments, substantially all of the non-aqueous liquid vehicle is evaporated from the droplets to form agglomerates comprised of the particles and the binder material.

In one or more embodiments, the gaseous carrier stream is heated prior to being mixed with the droplets. In one or more embodiments, the gaseous carrier stream is at a temperature in the range of from greater than or equal to 50 °C to less than or equal to 500 °C, including all greater than or equal to 80 °C to less than or equal to 300 °C, greater than or equal to 50 °C to less than or equal to 150 °C, and all values and subranges therebetween. If droplets collide but contain only a small amount of liquid (such as only internally), the droplets may not coalesce to a spherical shape. In some embodiments, non-spherical agglomerates may provide desirable filtration performance.

In one or more embodiments, the atomizing gas is heated to form a heated atomizing gas, which is then flowed through and/or contacted with the nozzle. In one or more embodiments, the heated atomizing gas is at a temperature in the range of from greater than or equal to 50 °C to less than or equal to 500 °C, including all greater than or equal to 80 °C to less than or equal to 300 °C, greater than or equal to 50 °C to less than or equal to 150 °C, and all values and subranges therebetween.

Carrier gas can be supplied to the apparatus to facilitate drying and carrying the liquid-particulate-binder droplets and resulting agglomerates through the apparatus and into the honeycomb body. In one or more embodiments, the carrier gas is predominantly an inert gas, such as nitrogen. In one or more embodiments, the carrier gas consists essentially of an inert gas. In one or more embodiments, the carrier gas is predominantly one or more inert gases. In one or more embodiments, the carrier gas is predominantly nitrogen gas. In one or more embodiments, the carrier gas is predominantly air. In one or more embodiments, the carrier gas consists essentially of nitrogen or air. In one or more embodiments, the carrier gas is dry. In one or more embodiments, the carrier gas comprises essentially no liquid vehicle upon entry to the chamber. In one or more embodiments, the carrier gas comprises less than 5 weight percent water vapor. In one or more embodiments, the carrier gas is heated prior to being mixed with the droplets. In one or more embodiments, the carrier gas is at a temperature in the range of from greater than or equal to 50 °C to less than or equal to 500 °C, including all greater than or equal to 80 °C to less than or equal to 300 °C, greater than or equal to 50 °C to less than or equal to 150 °C, and all values and subranges therebetween.

Upon intermixing of the gaseous carrier stream with the liquid-particulate-binder droplets inside the chamber, a gas-liquid-particulate-binder mixture can be formed. The gas-liquid-particulate-binder mixture is heated at the intermixing zone. In one or more embodiments, droplets of liquid containing particles and binder are present during the intermixing. In one or more embodiments, the gaseous carrier stream is heated prior to intermixing with the liquid-particulate-binder droplets.

The secondary particles or agglomerates of the primary particles are carried in gas flow, and the secondary particles or agglomerates, and/or aggregates thereof, are deposited on inlet wall surfaces of the honeycomb body when the gas passes through the honeycomb body. In one or more embodiments, the agglomerates and/or aggregates thereof are deposited onto the porous walls of the plugged honeycomb body. The deposited agglomerates may be disposed on, or in, or both on and in, the porous walls. In one or more embodiments, the plugged honeycomb body comprises inlet channels which are plugged at a distal end of the honeycomb body, and outlet channels which are plugged at a proximal end of the honeycomb body. In one or more embodiments, the agglomerates and/or aggregates thereof are deposited on, or in, or both on and in, the walls defining the inlet channels.

The flow can be driven by a fan, a blower or a vacuum pump. Additional air can be drawn into the system to achieve a desired flow rate.

The average diameter of the secondary particles or agglomerates is in a range of from 300 nm micrometer to 10 micrometers, 300 nm to 8 micrometers, 300 nm micrometer to 7 micrometers, 300 nm micrometer to 6 micrometers, 300 nm micrometer to 5 micrometers, 300 nm micrometer to 4 micrometers, or 300 nm micrometer to 3 micrometers. In specific embodiments, the average diameter of the secondary particles or agglomerates is in the range of 1.5 micrometers to 3 micrometers, including about 2 micrometers. The average diameter of the secondary particles or agglomerates can be measured by a scanning electron microscope.

The average diameter of the secondary particles or agglomerates is in a range of from 300 nm to 10 micrometers, 300 nm to 8 micrometers, 300 nm to 7 micrometers, 300 nm to 6 micrometers, 300 nm to 5 micrometers, 300 nm to 4 micrometers, or 300 nm to 3 micrometers, including the range of 1.5 micrometers to 3 micrometers, and including about 2 micrometers, and there is a ratio in the average diameter of the secondary particles or agglomerates to the average diameter of the primary particles of in range of from about 2:1 to about 67:1; about 2:1 to about 9:1; about 2:1 to about 8:1; about 2:1 to about 7:1; about 2:1 to about 6:1; about 2:1 to about 5:1; about 3:1 to about 10:1; about 3:1 to about 9:1; about 3:1 to about 8:1; about 3:1 to about 7:1; about 3:1 to about 6:1; about 3:1 to about 5:1; about 4:1 to about 10:1; about 4:1 to about 9:1; about 4:1 to about 8:1; about 4:1 to about 7:1; about 4:1 to about 6:1; about 4:1 to about 5:1; about 5:1 to about 10:1; about 5:1 to about 9:1; about 5:1 to about 8:1; about 5:1 to about 7:1; or about 5:1 to about 6:1, and including about 10:1 to about 20:1.

The depositing of the agglomerates onto the porous walls may further comprise passing the gaseous carrier stream through the porous walls of the honeycomb body, wherein the walls of the honeycomb body filter out at least some of the agglomerates by trapping the filtered agglomerates on or in the walls of the honeycomb body. In one or more embodiments, the depositing of the agglomerates onto the porous walls comprises filtering the agglomerates from the gaseous carrier stream with the porous walls of the plugged honeycomb body.

A post-treatment may optionally be used to adhere the agglomerates to the honeycomb body, and/or to each other. That is, in one or more embodiments, at least some of the agglomerates adhere to the porous walls. In one or more embodiments, the post-treatment comprises heating and/or curing the binder when present according to one or more embodiments. In one or more embodiments, the binder material causes the agglomerates to adhere or stick to the walls of the honeycomb body. In one or more embodiments, the binder material tackifies the agglomerates.

In one or more embodiments, the agglomerates and/or aggregates thereof are heated after being deposited on the honeycomb body. In one or more embodiments, the heating of the agglomerates causes an organic component of the binder material to be removed from the deposited agglomerates. In one or more embodiments, the heating of the agglomerates causes an inorganic component of the binder material to physically bond the agglomerates to the walls of the honeycomb body. In one or more embodiments, the heating of the agglomerates causes an inorganic component of the binder to form a porous inorganic structure on the porous walls of the honeycomb body. In one or more embodiments, the heating of the deposited agglomerates burns off or volatilizes an organic component of the binder material from the deposited agglomerates.

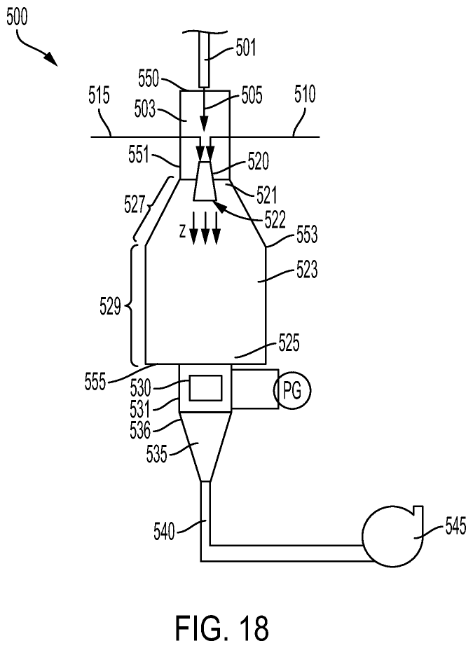

An example of an apparatus that may be used for processes to deposit inorganic material with binder on ceramic honeycomb bodies which can be used with tracer particles as described herein is shown in FIG. 18. Generally, apparatuses suitable for methods herein include a duct that defines a chamber. The duct may have several sections defining differing spaces and chambers. In one or more embodiments, the droplets and the gaseous carrier stream are conveyed through a duct having an outlet end proximate a plugged honeycomb body. The duct may comprise a converging section for engaging a proximal end of the honeycomb body. A converging section is advantageous in that fluid convection flow is enhanced. The duct may be in sealed fluid communication with the plugged honeycomb body during the depositing step. In one or more embodiments, the duct is adiabatic, or essentially adiabatic. In some embodiments, the nozzle temperature is regulated to achieve favorable atomization.

FIG. 18 shows an apparatus 500, Apparatus “A”, for forming honeycomb bodies, the apparatus 500 comprising a duct 551, a deposition zone 531, an exit zone 536, an exit conduit 540, and a flow driver 545.

The duct 551 spans from a first end 550 to a second end 555, defining a chamber of the duct comprising: a plenum space 503 at the first end 550 and an evaporation chamber 523 downstream of the plenum space 503. In one or more embodiments, the duct 551 is essentially adiabatic. That is, the duct 551 may have no external sources of heat. The evaporation chamber 523 is defined by an evaporation section 553 of the duct 551, which in this embodiment; comprises a first section of non-uniform diameter 527 and a second section of substantially uniform diameter 529. The evaporation section 553 comprises an inlet end 521 and an outlet end 525. The first section of non-uniform diameter 527 has a diameter that increases from the inlet end 521 toward the section of uniform diameter 529, which creates a diverging space for the flow to occupy.

A carrier gas is supplied to the duct 551 by a conduit 501, which may have a heat source to create a heated carrier gas 505. An atomizing gas 515 and a suspension 510 are separately supplied by individual delivery conduits such as tubing or piping to a nozzle 520, which is at the inlet end 521 of the evaporation section 553 and is in fluid communication with the duct 551, specifically in this embodiment with the evaporation chamber 523. The suspension 510 is atomized in the nozzle 520 with the atomizing gas 515. In one or more embodiments, the suspension 510 comprises an inorganic material, a non-aqueous liquid vehicle (such as ethanol), and a binder, as defined herein, which as supplied to the nozzle is a liquid-particulate-binder stream. The liquid-particulate-binder stream is atomized with the atomizing gas 515 into liquid-particulate-binder droplets by the nozzle 520.

In one or more embodiments, the heated carrier gas 505 flows over the nozzle 520. The atomizing gas 515 can be heated to form a heated atomizing gas. Temperature of the nozzle may be regulated as desired.

Outlet flow from the nozzle 520 and flow of the heated carrier gas 505 are both in a “Z” direction as shown in FIG. 18. There may be a diffusing area 522 downstream of the nozzle where at least some intermixing occurs. In this embodiment, the diffusing area 522 is located in the evaporation chamber 523, but in other embodiments, the diffusing area 522 may be located in the plenum space 503 depending on the location of the nozzle.

The outlet flow of from the nozzle intermixes with the heated carrier gas 505, thereby forming a gas-liquid-particulate-binder mixture, which flows through the chamber of the duct 551. Specifically, the gas-liquid-particulate-binder mixture flows through the evaporation chamber 523 of the evaporation section 553 and into the deposition zone 531 at the outlet end 525 of the evaporation section 553. At the intermixing, the gas-liquid-particulate-binder mixture is heated inside the chamber by the heated carrier gas.

In this embodiment, the outlet flow of the nozzle and the heated carrier gas enter the evaporation chamber 523 of the evaporation section 553 from substantially the same direction. In the evaporation chamber 523, substantially all of the liquid vehicle from the droplets is evaporated thereby forming agglomerates of the particles and the binder material, the agglomerates being interspersed in a gaseous carrier stream, which is comprised of the carrier gas and the atomizing gas.

The deposition zone 531 in fluid communication with the duct 551 houses a plugged ceramic honeycomb body 530, for example, a wall-flow particulate filter. The deposition zone 531 has an inner diameter that is larger than the outer diameter of the ceramic honeycomb body 530. To avoid leakage of the gases carrying the ceramic powders, the ceramic honeycomb body 530 is sealed to the inner diameter of deposition zone 531, a suitable seal is, for example, an inflatable “inner tube”. A pressure gauge, labelled as “PG” measures the difference in the pressure upstream and downstream from the particulate filter.

The gas-liquid-particulate-binder mixture flows into the ceramic honeycomb body 530 thereby depositing the inorganic material of the suspension on the ceramic honeycomb body. Specifically, the agglomerates and the gaseous carrier stream pass into the honeycomb body such that the gaseous carrier stream passes through the porous walls of the honeycomb body, and the walls of the honeycomb body trap the agglomerates, wherein the agglomerates and/or aggregates thereof are deposited on or in the walls of the honeycomb body. The inorganic material binds to the ceramic honeycomb body upon post-treatment to the ceramic honeycomb body. In an embodiment, binder material causes the agglomerates to adhere or stick to the walls of the honeycomb body.

Downstream from the ceramic honeycomb body 530 is an exit zone 536 defining an exit chamber 535. The flow driver 545 is downstream from the ceramic honeycomb body 530, in fluid communication with the deposition zone 531 and the exit zone 536 by way of the exit conduit 540. Non-limiting examples of flow drivers are: fan, blower, and vacuum pump. The aerosolized suspension is dried and deposited on one or more walls of the particulate filter as agglomerates of filtration material, which is present as discrete regions of filtration material, or in some portions or some embodiments as a layer, or both, wherein the agglomerates are comprised of primary particles of inorganic material.

Flow through embodiments such as apparatus 500 is considered in a downward direction, for example, substantially parallel to the direction of gravity. In other embodiments, the apparatus is configured such that flow is directed in a substantially upward or vertical direction.

Embodiments of ceramic articles herein can comprise honeycomb bodies comprised of a porous ceramic honeycomb structure of porous walls having wall surfaces defining a plurality of inner channels.

In some embodiments, the porous ceramic walls comprise a material such as a filtration material which may comprise in some portions or some embodiments a porous inorganic layer disposed on one or more surfaces of the walls. In some embodiments, the filtration material comprises one or more inorganic materials, such as one or more ceramic or refractory materials. In some embodiments, the filtration material is disposed on the walls to provide enhanced filtration efficiency, both locally through and at the wall and globally through the honeycomb body, at least in the initial use of the honeycomb body as a filter following a clean state, or regenerated state, of the honeycomb body, for example such as before a substantial accumulation of ash and/or soot occurs inside the honeycomb body after extended use of the honeycomb body as a filter.

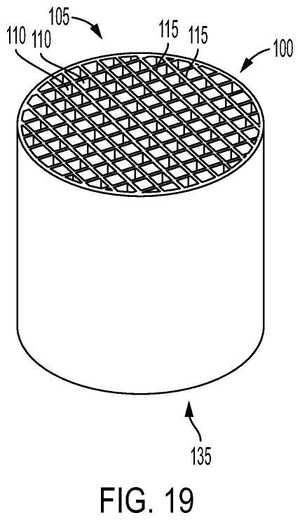

With reference now to FIG. 19, a honeycomb body 100 according to one or more embodiments shown and described herein is depicted. The honeycomb body 100 may, in embodiments, comprise a plurality of walls 115 defining a plurality of inner channels 110. The plurality of inner channels 110 and intersecting channel walls 115 extend between first end 105, which may be an inlet end, and second end 135, which may be an outlet end, of the honeycomb body. The honeycomb body may have one or more of the channels plugged on one, or both of the first end 105 and the second end 135. The pattern of plugged channels of the honeycomb body is not limited. In some embodiments, a pattern of plugged and unplugged channels at one end of the honeycomb body may be, for example, a checkerboard pattern where alternating channels of one end of the honeycomb body are plugged. In some embodiments, plugged channels at one end of the honeycomb body have corresponding unplugged channels at the other end, and unplugged channels at one end of the honeycomb body have corresponding plugged channels at the other end.

In one or more embodiments, the honeycomb body may be formed from cordierite, aluminum titanate, enstatite, mullite, forsterite, corundum (SiC), spinel, sapphirine, and periclase. In general, cordierite has a composition according to the formula Mg₂Al₄Si₅O₁₈. In some embodiments, the pore size of the ceramic material, the porosity of the ceramic material, and the pore size distribution of the ceramic material are controlled, for example by varying the particle sizes of the ceramic raw materials. In addition, pore formers can be included in ceramic batches used to form the honeycomb body.

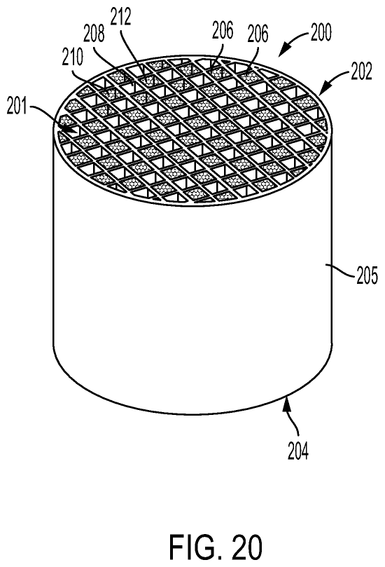

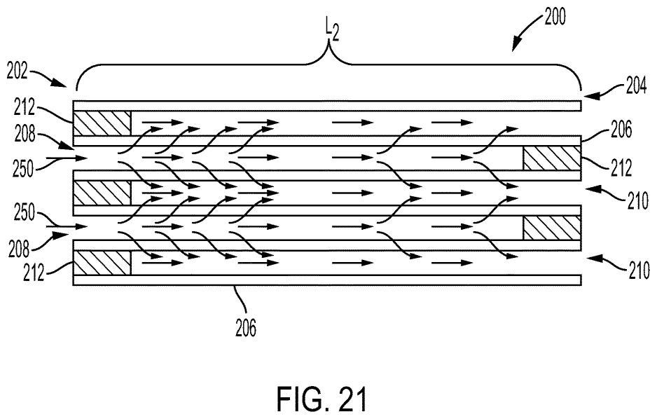

Referring now to FIGS. 20-21, a honeycomb body in the form of a particulate filter 200 is schematically depicted.

The particulate filter 200 may be used as a wall-flow filter to filter particulate matter from an exhaust gas stream 250, such as an exhaust gas stream emitted from a gasoline engine, in which case the particulate filter 200 is a gasoline particulate filter. The particulate filter 200 generally comprises a honeycomb body having a plurality of channels 201 or cells which extend between an inlet end 202 and an outlet end 204, defining an overall length La (shown in FIG. 21). The channels 201 of the particulate filter 200 are formed by, and at least partially defined by a plurality of intersecting channel walls 206 that extend from the inlet end 202 to the outlet end 204. The particulate filter 200 may also include a skin layer 205 surrounding the plurality of channels 201. This skin layer 205 may be extruded during the formation of the channel walls 206 or formed in later processing as an after-applied skin layer, such as by applying a skinning cement to the outer peripheral portion of the channels.

An axial cross section of the particulate filter 200 of FIG. 20 is shown in FIG. 21. In some embodiments, certain channels are designated as inlet channels 208 and certain other channels are designated as outlet channels 210. In some embodiments of the particulate filter 200, at least a first set of channels may be plugged with plugs 212. Generally, the plugs 212 are arranged proximate the ends (i.e., the inlet end or the outlet end) of the channels 201. The plugs are generally arranged in a pre-defined pattern, such as in the checkerboard pattern shown in FIG. 20, with every other channel being plugged at an end. The inlet channels 208 may be plugged at or near the outlet end 204, and the outlet channels 210 may be plugged at or near the inlet end 202 on channels not corresponding to the inlet channels, as depicted in FIG. 21. Accordingly, each cell may be plugged at or near one end of the particulate filter only.

FIG. 20 depicts a checkerboard plugging pattern, although alternative plugging patterns may be implemented in the porous ceramic honeycomb article.

In embodiments the honeycomb body is configured to filter particulate matter from a gas stream, for example, an exhaust gas stream from a gasoline engine. The mean pore size, porosity, geometry and other design aspects of both the bulk and the surface of the honeycomb body are selected taking into account these filtration requirements of the honeycomb body. As an example, a wall of the honeycomb body, which can be in the form of the particulate filter body as shown in FIGS. 20 and 21, has filtration material deposits disposed thereon, which in some embodiments is sintered or otherwise bonded by heat treatment. The filtration material deposits comprise particles that are deposited on the wall of the honeycomb body and help prevent particulate matter from exiting the honeycomb body along with the gas stream, such as, for example, soot and/or ash, and to help prevent the particulate matter from clogging the base portion of the walls of the honeycomb body. In this way, and according to embodiments, the filtration material deposits can serve as the primary filtration component while the base portion of the honeycomb body can be configured to otherwise minimize pressure drop for example as compared to honeycomb bodies without such filtration material deposits. The filtration material deposits are delivered by the aerosol deposition methods disclosed herein.

As discussed above, the deposited material, which may in some portions or some embodiments be an inorganic layer, can be applied to the walls of the honeycomb body by methods that permit the inorganic material, which may be an inorganic layer, to have a small mean pore size. This small mean pore size allows the material, which may be an inorganic layer, to filter a high percentage of particulate and prevents particulate from penetrating honeycomb and settling into the pores of the honeycomb. The small mean pore size of material, which may be an inorganic layer, according to embodiments increases the filtration efficiency of the honeycomb body.

As described above with reference to FIG. 21, the honeycomb body can have a first end and second end. The first end and the second end are separated by an axial length “L”.

The material, which is in some embodiments an inorganic filtration material, on the walls of the honeycomb body according to embodiments is thin and has a porosity, and in some embodiments also has good chemical durability and physical stability. The chemical durability and physical stability of the filtration material deposits on the honeycomb body can be determined, in embodiments, by subjecting the honeycomb body to test cycles comprising burn out cycles and an aging test and measuring the initial filtration efficiency before and after the test cycles. For instance, one exemplary method for measuring the chemical durability and the physical stability of the honeycomb body comprises measuring the initial filtration efficiency of a honeycomb body; loading soot onto the honeycomb body under simulated operating conditions; burning out the built up soot at about 650 °C; subjecting the honeycomb body to an aging test at 1050 °C and 10% humidity for 12 hours; and measuring the filtration efficiency of the honeycomb body. Multiple soot build up and burnout cycles may be conducted. A small change in filtration efficiency (AFE) from before the test cycles to after the test cycles indicates better chemical durability and physical stability of the filtration material deposits on the honeycomb body. In some embodiments, the AFE is less than or equal to 5%, such as less than or equal to 4%, or less than or equal to 3%. In other embodiments, the AFE is less than or equal to 2%, or less than or equal to 1%. The use of tracer particles as described herein can be implemented to determine such filtration efficiencies and/or changes in filtration efficiencies.

According to one or more embodiments, a liquid suspension of inorganic material and binder passes through a nozzle and provides a flow of aerosol particles after contact with a gas stream and heat before being forced into the opening channels of the honeycomb body. A layer of inorganic material is then deposited on the porous walls with some agglomerates or inorganic material getting into pores. An off-line heat treatment process may be applied for curing of the layer, which in some embodiments forms a membrane. According to one or more embodiments, the honeycomb bodies made and described herein, both before and after curing, exhibit significantly higher filtration efficiency and/or better FE/dP trade-off than bare honeycomb body substrate parts.

As used herein, the “clean filtration efficiency” of a honeycomb body or filtration article refers to a new or regenerated honeycomb body that does not comprise any measurable soot loading. The clean filtration efficiency of the honeycomb body or filtration article is greater than or equal to 70%, such as greater than or equal to 80%, or greater than or equal to 85%. In yet other embodiments, the initial filtration efficiency of the honeycomb body or filtration article is greater than 90%, such as greater than or equal to 93%, or greater than or equal to 95%, or greater than or equal to 98%.

Clean filtration efficiency (at 30 °C unless otherwise specified) is determined by measuring the difference between a number of particulates that are introduced into the article and a number of particulates that exit the article before and after exposure to the flow conditions.

We have found that the first particles can help avoid deep penetration of the second particles (such as alumina particles): without sacrificial particles the penetration of second particles could penetrate into the honeycomb wall beyond 50% of the wall thickness and into the wall, while with sacrificial particles the penetration of second particles can be less than 25% below the wall surface, i.e. penetration less than 25% into the honeycomb wall. Correspondingly we have found that a lower pressure drop occurs for no, or shallow, penetration of the second particles as demonstrated in the examples.

Higher material utilization of the secondary particles due to preventing them slip through the pores at the beginning of the deposition. As described in the examples, for the same amount of the second suspension, higher filtration material (second particles) loading was observed with use of sacrificial particles.

It will be apparent to those skilled in the art that various modifications and variations can be made to the embodiments described herein without departing from the spirit and scope of the claimed subject matter. Thus, it is intended that the specification cover the modifications and variations of the various embodiments described herein provided such modification and variations come within the scope of the appended claims and their equivalents.

25. The method of claim 20, wherein at least some of the axial channels are blocked during the delivering of the first particles to induce the carrier fluid to pass through one or more of the porous walls from at least one axial channel to another adjacent axial channel.

26. The method of claim 1, wherein at least some of the sacrificial particles bridge across at least some of the surface openings.

27. The method of claim 1, wherein the selected amount of the first particles per volume of the honeycomb structure is in a range of 0.1 to 5.0 grams/liter.

28.-33. (canceled)

34. The method of claim 1, wherein a primary particle size of the sacrificial particles is in a range of 0.1 μm to 4 μm.

35.-40. (canceled)

41. The method of claim 1, wherein a median pore size of the internal pores is in a range of 5 micrometers to 50 micrometers.

42.-43. (canceled)

1. A method of manufacturing an article, comprising:
delivering first particles from a first suspension of first particles axially into a honeycomb structure extending axially from a first face to a second face, the structure comprising a plurality of porous walls extending axially and comprising surfaces defining a plurality of axial channels, the porous walls comprising internal pores, wherein surfaces of the porous walls comprise surface openings to at least some of the internal pores, the delivering comprising flowing the first particles into the axial channels to deposit the first particles onto the porous walls such that at least some of the first particles are disposed in, over, and/or around the surface openings;
terminating the delivering of the first particles into the axial channels after a selected amount of first particles has been deposited within the honeycomb structure, wherein the selected amount of first particles per volume of the honeycomb structure is greater than 0.01 grams/liter and less than 5.0 grams/liter; and
wherein the first particles are comprised of sacrificial particles comprising an organic material comprising macromolecules, one or more polymers, or combinations thereof.

2. The method of claim 1, wherein the organic material comprises protein particles, whey protein particles, collagen peptide particles, or combinations thereof.

3. The method of claim 2, wherein the organic material comprises protein particles comprising a primary size less than 1 μm while in suspension and a secondary particle size or aggregate particle size less than 10 μm upon deposition to the porous walls of the honeycomb structure.

4. The method of claim 1, wherein the sacrificial particles further comprise calcium and phosphorus.

5. (canceled)

6. The method of claim 1, wherein the organic material comprises a starch.

7. The method of claim 1, wherein the organic material comprises a synthetic polymer.

8.-9. (canceled)

10. The method of claim 1, further comprising, after flowing the first suspension, delivering second particles from a second suspension of the second particles axially into the axial channels and depositing the second particles onto the porous walls, the deposited sacrificial particles blocking at least some of the second particles from entering the internal pores.

11. The method of claim 10, wherein the sacrificial particles block at least a majority of the second particles from entering the internal pores.

12. (canceled)

13. The method of claim 10, wherein the second particles do not penetrate below the surfaces of the porous walls more than 25% of a transverse thickness of the porous walls.

14. (canceled)

15. The method of claim 10, further comprising terminating the delivering of the second particles into the channels after a selected amount of second particles per volume of the honeycomb structure greater than 0.01 grams/liter and less than 8.0 grams/liter has been deposited within the honeycomb structure.

16. The method of claim 15, wherein the terminating the delivering of the second particles occurs when the selected amount of second particles is in a range of 1.0 grams/liter to 8.0 grams/liter.

17.-19. (canceled)

20. The method of claim 1, wherein the first suspension comprises the first sacrificial particles and a carrier fluid.

21. The method of claim 20, wherein the carrier fluid is a gas.

22. The method of claim 1, wherein the sacrificial particles are disposed in less than all of the internal pores of the porous walls comprising surface openings.

23. The method of claim 1, wherein the sacrificial particles do not penetrate below the surfaces of the porous walls more than 50% of a transverse thickness of the porous walls.

24. (canceled)

25. The method of claim 20, wherein at least some of the axial channels are blocked during the delivering of the first particles to induce the carrier fluid to pass through one or more of the porous walls from at least one axial channel to another adjacent axial channel.

26. The method of claim 1, wherein at least some of the sacrificial particles bridge across at least some of the surface openings.

27. The method of claim 1, wherein the selected amount of the first particles per volume of the honeycomb structure is in a range of 0.1 to 5.0 grams/liter.

28.-33. (canceled)

34. The method of claim 1, wherein a primary particle size of the sacrificial particles is in a range of 0.1 μm to 4 μm.

35.-40. (canceled)

41. The method of claim 1, wherein a median pore size of the internal pores is in a range of 5 micrometers to 50 micrometers.

42.-43. (canceled)
